(19) United States
(12) Patent Application Publication
(10) Pub. No.: US 2026/0032663 A1
(43) Pub. Date: Jan. 29, 2026

(54) INDICATION OF BEAM IDENTIFIER IN BEAM PREDICTION REPORTING

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/145,074

(22) PCT Filed: Feb. 17, 2023
(86) PCT No.: PCT/CN2023/076695

§ 371 Date: Jul. 1, 2025

(51) Int. Cl. H04W 72/044; H04W 24/10; H04W 72/21

(52) U.S. Cl. CPC H04W 72/046; H04W 24/10; H04W 72/21

(57) ABSTRACT

Methods, systems, and devices for wireless communications are described. A user equipment (UE) may receive a signal indicating measurement reporting parameters for the UE, the measurement reporting parameters identifying a set of beam prediction resources for a set of beams and a beam measurement reporting scheme. The UE may transmit a beam measurement report indicating beam resource identifiers associated with a subset of beams from the set of beams, each beam in the subset of beams satisfying a performance threshold for corresponding beam prediction resources in the set of beam prediction resources associated with the measurement reporting parameters, wherein the beam resource identifiers of beams in the subset of beams are based at least in part on the beam measurement reporting scheme.

### CROSS REFERENCE

The present application is a 371 national phase filing of International PCT Application No. PCT/CN2023/076695 by L I et al., entitled “INDICATION OF BEAM IDENTIFIER IN BEAM PREDICTION REPORTING,” filed Feb. 17, 2023, which is assigned to the assignee hereof, and which is expressly incorporated by reference in its entirety herein.

### FIELD OF TECHNOLOGY

The following relates to wireless communications, including indication of beam identifier in beam prediction reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support indication of beam identifier in beam prediction reporting. For example, the described techniques provide for enabling reporting of predicted measurement resource identifiers in a measurement report, such as a beam measurement report. For example, a user equipment (UE) may be configured with (e.g., receive, obtain, or otherwise access or store) measurement reporting parameters (e.g., a channel state information (CSI) report setting) that identify or otherwise indicate a set of beam prediction resources for a set of beams (e.g., a prediction resource set) that are associated with the measurement reporting parameters, such as a measurement reporting quantity (e.g., reportQuantity). The measurement reporting quantity may generally indicate that the UE is to report the top K resource identifiers (K being a positive integer) associated with beams in the set of beams having the strongest predicted measurement results (e.g., the beams that satisfy a performance threshold). The measurement reporting parameters may also indicate or otherwise identify a beam measurement reporting scheme, which may define the format of the beam measurement report (e.g., such as what information to include in the beam measurement report, how the information is presented or arranged, and the like). The UE may transmit or otherwise provide the beam measurement report to the network indicating the resource identifiers associated with a subset of beams. The subset of beams may include beams from the set of beams that have satisfied the performance threshold (e.g., the top K predicted beams that are the strongest among the set). The resource identifiers indicated in the beam measurement report may be configured (e.g., ordered or otherwise indicated, what information is reported, and the like) according to the beam measurement reporting scheme.

A method for wireless communication at a UE is described. The method may include receiving a signal indicating measurement reporting parameters for the UE, the measurement reporting parameters identifying a set of beam prediction resources for a set of beams and a beam measurement reporting scheme and transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

An apparatus for wireless communication at a UE is described. The apparatus may include a processor, memory coupled with the processor, and instructions stored in the memory. The instructions may be executable by the processor to cause the apparatus to receive a signal indicating measurement reporting parameters for the UE, the measurement reporting parameters identifying a set of beam prediction resources for a set of beams and a beam measurement reporting scheme and transmit a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

Another apparatus for wireless communication at a UE is described. The apparatus may include means for receiving a signal indicating measurement reporting parameters for the UE, the measurement reporting parameters identifying a set of beam prediction resources for a set of beams and a beam measurement reporting scheme and means for transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

A non-transitory computer-readable medium storing code for wireless communication at a UE is described. The code may include instructions executable by a processor to receive a signal indicating measurement reporting parameters for the UE, the measurement reporting parameters identifying a set of beam prediction resources for a set of beams and a beam measurement reporting scheme and transmit a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

Some examples of the method, apparatuses, and non-transitory computer-readable medium described herein may further include operations, features, means, or instructions for receiving, as one of the measurement reporting parameters, a reporting quantity indicating a number of resource identifiers to be indicated in the beam measurement report, where the subset of beams may be based on beams satisfying the performance threshold and the reporting quantity.

In some examples of the method, apparatuses, and non-transitory computer-readable medium described herein, the performance threshold may be based on a predicted reference signal received power (RSRP), a predicted signal-to-interference-plus-noise ratio (SINR), or both, of each beam in the subset of beams being higher than the RSRP, SINR, or both, of remaining beams in the set of beams.

Some examples of the method, apparatuses, and non-transitory computer-readable medium described herein may further include operations, features, means, or instructions for applying, based on the measurement reporting scheme, an ordering scheme to the resource identifiers indicated in the beam measurement report.

Some examples of the method, apparatuses, and non-transitory computer-readable medium described herein may further include operations, features, means, or instructions for according to the ordering scheme each resource identifier may be ordered within the beam measurement report according to a predicted beam measurement result associated with each beam in the subset of beams.

In some examples of the method, apparatuses, and non-transitory computer-readable medium described herein, the ordering scheme defines a bitmap associated with the set of beam prediction resources and each bit in the bitmap corresponds to a beam in the set of beams, with each bit being set to indicate that the beam may be included in the subset of beams.

In some examples of the method, apparatuses, and non-transitory computer-readable medium described herein, the ordering scheme defines a combinatorial index based on a first number of beam prediction resources in the set of beam prediction resources and second number of beams in the subset of beams.

Some examples of the method, apparatuses, and non-transitory computer-readable medium described herein may further include operations, features, means, or instructions for setting a first field in the beam measurement report to indicate transmission of a second beam measurement report according to second measurement reporting parameters identifying a second beam measurement reporting scheme and transmitting, according to the second beam measurement reporting scheme, the second beam measurement report indicating resource identifiers associated with a second subset of beams from a second set of beams and a predicted measurement result for each beam in the second subset of beams, the second beam measurement report further including a second field associating the second beam measurement report with the beam measurement report.

In some examples of the method, apparatuses, and non-transitory computer-readable medium described herein, the set of beam prediction resources and a second set of beam prediction resources identified by the second beam measurement reporting parameters include a same resource set.

Some examples of the method, apparatuses, and non-transitory computer-readable medium described herein may further include operations, features, means, or instructions for transmitting a request to switch from the beam measurement reporting scheme to a second beam measurement reporting scheme, the second beam measurement reporting scheme associated with second measurement reporting parameters identifying a second set of beam prediction resources.

In some examples of the method, apparatuses, and non-transitory computer-readable medium described herein, an uplink control information (UCI) message, a medium access control-control element (MAC-CE), a radio resource control (RRC) message, or a combination thereof.

Some examples of the method, apparatuses, and non-transitory computer-readable medium described herein may further include operations, features, means, or instructions for receiving a request to switch to a second beam measurement reporting scheme based on a confidence level, the confidence level associated with each beam in the subset of beams satisfying the performance threshold.

In some examples of the method, apparatuses, and non-transitory computer-readable medium described herein, the beam measurement report may be received in one or more of an UCI message, an RRC message, a MAC-CE, or a combination thereof, and a second beam measurement report associated with the beam measurement report may be transmitted in a second UCI message, a second RRC message, a second MAC-CE, or a combination thereof.

A method for wireless communication at a network entity is described. The method may include transmitting, to a UE, a signal indicating measurement reporting parameters for the UE, the measurement reporting parameters identifying a set of beam prediction resources for a set of beams and a beam measurement reporting scheme and receiving, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

An apparatus for wireless communication at a network entity is described. The apparatus may include a processor, memory coupled with the processor, and instructions stored in the memory. The instructions may be executable by the processor to cause the apparatus to transmit, to a UE, a signal indicating measurement reporting parameters for the UE, the measurement reporting parameters identifying a set of beam prediction resources for a set of beams and a beam measurement reporting scheme and receive, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

Another apparatus for wireless communication at a network entity is described. The apparatus may include means for transmitting, to a UE, a signal indicating measurement reporting parameters for the UE, the measurement reporting parameters identifying a set of beam prediction resources for a set of beams and a beam measurement reporting scheme and means for receiving, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

A non-transitory computer-readable medium storing code for wireless communication at a network entity is described. The code may include instructions executable by a processor to transmit, to a UE, a signal indicating measurement reporting parameters for the UE, the measurement reporting parameters identifying a set of beam prediction resources for a set of beams and a beam measurement reporting scheme and receive, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

Some examples of the method, apparatuses, and non-transitory computer-readable medium described herein may further include operations, features, means, or instructions for transmitting, as one of the measurement reporting parameters, a reporting quantity a number of resource identifiers to be indicated in the beam measurement report, where the subset of beams may be based on the beams satisfying the performance threshold and the reporting quantity.

Some examples of the method, apparatuses, and non-transitory computer-readable medium described herein may further include operations, features, means, or instructions for identifying a first field in the beam measurement report that indicates transmission of a second beam measurement report from the UE according to second measurement reporting parameters identifying a second beam measurement reporting scheme and receiving, according to the second beam measurement reporting scheme, the second beam measurement report indicating resource identifiers associated with a second subset of beams from a second set of beams and a predicted measurement result for each beam in the second subset of beams, the second beam measurement report further including a second field associating the second beam measurement report with the beam measurement report.

In some examples of the method, apparatuses, and non-transitory computer-readable medium described herein, the set of beam prediction resources and a second set of beam prediction resources identified by the second beam measurement reporting parameters include a same resource set.

Some examples of the method, apparatuses, and non-transitory computer-readable medium described herein may further include operations, features, means, or instructions for transmitting, to the UE, a request to switch from the beam measurement reporting scheme to a second beam measurement reporting scheme, the second beam measurement reporting scheme associated with second measurement reporting parameters identifying a second set of beam prediction resources.

In some examples of the method, apparatuses, and non-transitory computer-readable medium described herein, an UCI message, a MAC-CE, an RRC message, or a combination thereof.

In some examples of the method, apparatuses, and non-transitory computer-readable medium described herein, identifying, based on the beam measurement report, a confidence level associated with each beam in the subset of beams satisfying the performance threshold and transmitting, to the UE, a request to switch to a second beam measurement reporting scheme based on a confidence level, the confidence level associated with each beam in the subset of beams satisfying the performance threshold.

In some examples of the method, apparatuses, and non-transitory computer-readable medium described herein, the beam measurement report may be received in one or more of an UCI message, an RRC message, a MAC-CE, or a combination thereof, and a second beam measurement report associated with the beam measurement report may be transmitted in a second UCI message, a second RRC message, a second MAC-CE, or a combination thereof.

### BRIEF DESCRIPTION OF THE DRAWINGS

FIG. 1 illustrates an example of a wireless communications system that supports indication of beam identifier in beam prediction reporting in accordance with one or more aspects of the present disclosure.

FIG. 2 illustrates an example of a wireless communications system that supports indication of beam identifier in beam prediction reporting in accordance with one or more aspects of the present disclosure.

FIG. 3 illustrates an example of a reporting scheme that supports indication of beam identifier in beam prediction reporting in accordance with one or more aspects of the present disclosure.

FIG. 4 illustrates an example of a reporting scheme that supports indication of beam identifier in beam prediction reporting in accordance with one or more aspects of the present disclosure.

FIG. 5 illustrates an example of a reporting scheme that supports indication of beam identifier in beam prediction reporting in accordance with one or more aspects of the present disclosure.

FIG. 6 illustrates an example of a reporting scheme that supports indication of beam identifier in beam prediction reporting in accordance with one or more aspects of the present disclosure.

FIGS. 7 and 8 illustrate block diagrams of devices that support indication of beam identifier in beam prediction reporting in accordance with one or more aspects of the present disclosure.

FIG. 9 illustrates a block diagram of a communications manager that supports indication of beam identifier in beam prediction reporting in accordance with one or more aspects of the present disclosure.

FIG. 10 illustrates a diagram of a system including a device that supports indication of beam identifier in beam prediction reporting in accordance with one or more aspects of the present disclosure.

FIGS. 11 and 12 illustrate block diagrams of devices that support indication of beam identifier in beam prediction reporting in accordance with one or more aspects of the present disclosure.

FIG. 13 illustrates a block diagram of a communications manager that supports indication of beam identifier in beam prediction reporting in accordance with one or more aspects of the present disclosure.

FIG. 14 illustrates a diagram of a system including a device that supports indication of beam identifier in beam prediction reporting in accordance with one or more aspects of the present disclosure.

FIGS. 15 through 19 illustrate flowcharts showing methods that support indication of beam identifier in beam prediction reporting in accordance with one or more aspects of the present disclosure.

### DETAILED DESCRIPTION

Wireless networks may rely on channel performance measurement and reporting techniques to determine and monitor the performance of a wireless channel over which communications are being performed. This may include reference signal resources (e.g., measurement resources) being configured for a user equipment (UE), with the UE measuring signal(s) transmitted via the resources (e.g., actual measurement results) to determine aspects of the channel performance. This may also include the UE modeling the predicted channel performance (e.g., predicted measurement results) using various proxy information, such as previous measurements on the channel, measurements on adjacent channels, and so forth. The UE may report the measurement results (e.g., actual or predicted) to the network by signaling an identifier of the reference signal resource as well as the measurement results (e.g., reference signal receive power (RSRP) level, signal-to-interference-plus-noise (SINR) level, and the like). The results of the reporting may be applied when making various scheduling or allocation decisions, for beam management, and other uses, by the nodes of the wireless network. However, in some situations the predicted measurement results (e.g., RSRP/SINR) may be unnecessary from the perspective of the network. This may result in unnecessary signaling and reporting requirements associated with signaling the predicted measurement results, which may decrease efficiency and increase latency of the wireless network.

The described techniques provide for enabling reporting of predicted measurement resource identifiers in a measurement report, such as a beam measurement report. For example, a UE may be configured with (e.g., receive, obtain, or otherwise access or store) measurement reporting parameters (e.g., a channel state information (CSI) report setting) that identify or otherwise indicate a set of beam prediction resources (e.g., reference signal resources) for a set of beams (e.g., a beam prediction resource set) that are associated with the measurement reporting parameters, such as a measurement reporting quantity (e.g., reportQuantity). The measurement reporting quantity may generally indicate that the UE is to report the top K resource identifiers (K being a positive integer) associated with beams in the set of beams having the strongest predicted measurement result (e.g., the beams that satisfy a performance threshold). The measurement reporting parameters may also indicate or otherwise identify a beam measurement reporting scheme, which may define the format of the beam measurement report (e.g., such as what information to include in the beam measurement report, how the information is presented or arranged, and the like). The UE may transmit or otherwise provide the beam measurement report to the network indicating the resource identifiers associated with a subset of beams. The subset of beams may include beams from the set of beams that have satisfied the performance threshold (e.g., the top K predicted beams that are the strongest among the set). The resource identifiers indicated in the beam measurement report may be configured (e.g., ordered or otherwise indicated, what information is reported, and the like) according to the beam measurement reporting scheme.

Aspects of the disclosure are initially described in the context of wireless communications systems. Aspects of the disclosure are further illustrated by and described with reference to apparatus diagrams, system diagrams, and flowcharts that relate to indication of beam identifier in beam prediction reporting.

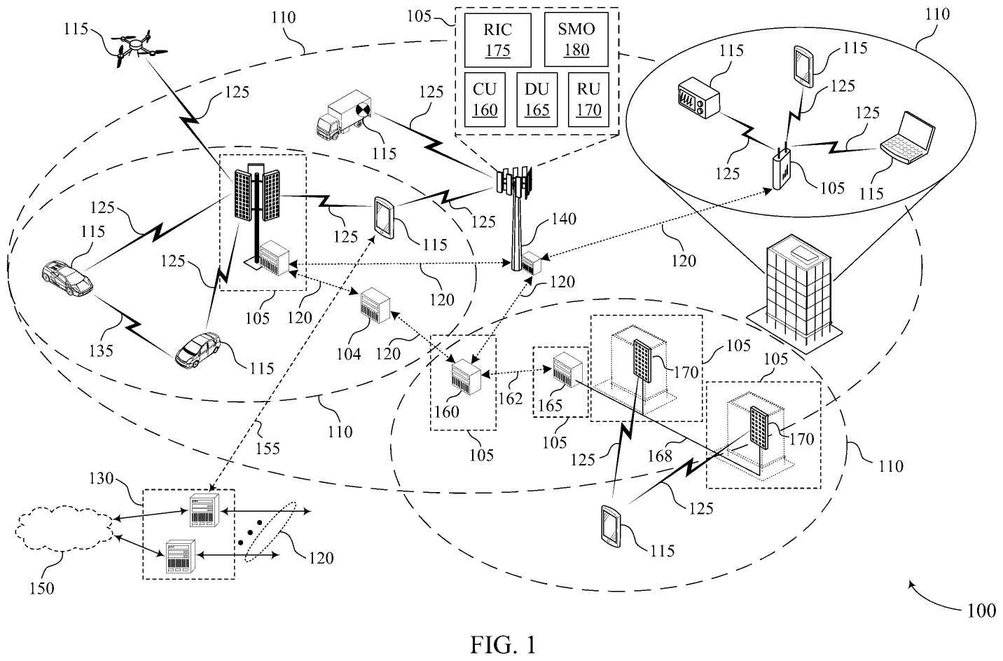

FIG. 1 illustrates an example of a wireless communications system 100 that supports indication of beam identifier in beam prediction reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support indication of beam identifier in beam prediction reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna array's that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive a signal indicating measurement reporting parameters for the UE 115, the measurement reporting parameters identifying a set of beam prediction resources for a set of beams and a beam measurement reporting scheme. The UE 115 may transmit a beam measurement report indicating resource identifiers associated with a subset of beams from the set of beams, each beam in the subset of beams satisfying a performance threshold for corresponding beam prediction resources in the set of beam prediction resources associated with the measurement reporting parameters, wherein the resource identifiers of beams in the subset of beams are based at least in part on the beam measurement reporting scheme.

A network entity 105 may transmit, to a UE 115, a signal indicating measurement reporting parameters for the UE 115, the measurement reporting parameters identifying a set of beam prediction resources for a set of beams and a beam measurement reporting scheme. The network entity 105 may receive, from the UE 115, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, wherein the resource identifiers of beams in the subset of beams are based at least in part on the beam measurement reporting scheme.

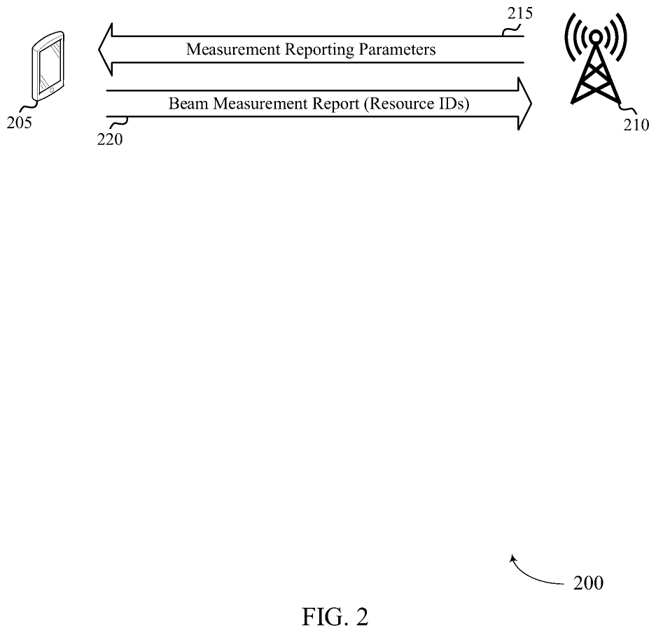

FIG. 2 illustrates an example of a wireless communications system 200 that supports indication of beam identifier in beam prediction reporting in accordance with one or more aspects of the present disclosure. Wireless communications system 200 may implement aspects of wireless communications system 100. Wireless communications system 200 may include a UE 205 and/or a network entity 210, which may be examples of the corresponding devices described herein.

Wireless communications system 200 may support beam management functions, such as beam performance measurement and reporting, beam failure condition resolution, and the like. For example, transmit beams of a transmitting device (e.g., the UE 205 and/or the network entity 210) may be used for transmitting wireless signals over the air towards a receiving device. The transmit beam may generally support techniques to realize a signaling gain using beamforming techniques. The beamforming techniques allow the transmitting device to extend its communication range by steering a waveform in a directional manner. The transmitting device may use various antennas/antenna arrays, weighting algorithms, and the like, transmitting at different transmit power levels that operate to steer the beam toward a particular direction. These techniques allow the transmitting device to conserve its transmit power and reduce network interference. The receiving device may use receive beam(s) in a similar manner to direct its receive antenna/antenna arrays towards the transmitting device.

Management of the beams (e.g., the transmit beams) may include performing beam measurement and reporting procedures conducted between the transmitting device (e.g., the network entity 210 in this example) and the receiving device (e.g., the UE 205 in this example). The network entity 210 may configure the UE 205 (e.g., by transmitting to the UE) with CSI report settings identifying various measurement reporting parameters for the UE 205. The measurement reporting parameters may broadly define the CSI measurement resources (CMR) (e.g., indicate a CMR identifier (CMR-ID), such as a resource identifier, which are linked to time, frequency, and/or spatial resources) as well as aspects of the resulting measurement report. The UE 205 may measure signal(s) transmitted by the network entity 210 (e.g., transmitted in the physical resources corresponding to the resource identifier) using its transmit beam(s) to determine how well the channel is performing (e.g., RSRP/SINR measurement values) using the given transmit beam. The UE 205 may transmit a measurement report to the network entity 210 indicating the measurement results (e.g., RSRP/SINR) values along with an identifier associated with the transmit beam (e.g., a reference signal resource identifier, such as the CMR-ID, that is linked or otherwise associated with the transmit beam transmitted over the resources). The network entity 210 may use the beam measurement results to determine the performance of its transmit beam(s) and make scheduling and/or configuration decisions accordingly. For example, the network entity 210 may use the beam measurement results to select which transmit beams to use based on the measurement results and the location of the UE 205.

In some examples, the beam measurement and reporting procedures may be based on predicted beam performance (e.g., may indicate predicted measurement results rather than actually measured measurement results). For example, the measurement reporting parameters may identify a set of beam prediction resources (e.g., using a resource identifier, such as a CMR-ID, that is linked to actual resources or logical resources) that are to be used by the UE 205 to predict the performance (e.g., predicted RSRP/SINR) of the transmit beam(s) of the network entity 210. The UE 205 may predict the performance of the transmit beam(s) associated with the beam prediction resources in the set (e.g., to determine predicted RSRP/SINR values for the transmit beam(s) using the beam prediction resources) and report this information, along with the resource identifier, to the network entity 210. The UE 205 may use historical and/or recent measurement results on the same beams or different beams to determine the predicted measurement results. Such predictive beam management techniques where beam prediction in the time and/or spatial domain is performed may reduce overhead and latency, improve beam selection accuracy, and more. Such measurement and reporting procedures may also be referred to as layer one (L1) measurement and reporting procedures (e.g., L1-RSRP/SINR) as the measurements and/or predictions are based on over-the-air resources, propagation paths, previous/current measurement results of the wireless channel, and the like.

Such beam measurement and reporting procedures may be helpful in some situations, but may be inefficient in others. Broadly, the predicted measurement results predicted by the UE 205 may be associated with a confidence level. That is and for each, some or all of the predicted measurement results (e.g., the predicted L1-RSRP/SINR) may have an associated confidence level indicative of how certain the predicted measurement result is accurate. The confidence level may be based on how old the previous measurement result (e.g., actual measurement results) is, on which beam the previous measurement results were obtained (e.g., same or different), and the like. In some examples, when a confidence level associated with the predicted RSRP/SINR results is high (e.g., satisfies a threshold), it may be helpful for the measurement report to indicate both the predicted measurement results (e.g., the L1-RSRP/SINR) as well as the corresponding resource identifier (e.g., CMR-ID). When the confidence level is low (e.g., fails to satisfy the threshold and/or satisfies the threshold but is based on old information), including the predicted measurement results in the measurement report may be inefficient and unnecessarily increase uplink overhead. However, some wireless networks are configured such that all L1 reports should include both the predicted measurement results (e.g., the predicted L1-RSRP/SINR) as well as the resource identifier (e.g., CMR-ID). Reporting the predicted measurement results, when such results are associated with low confidence levels adds significant data (e.g., bits) to the measurement report, with little to no advantage to the network performance and/or the communications between the UE 205 and the network entity 210.

Accordingly, aspects of the techniques described herein provide mechanisms to permit the UE 205 to signal the resource identifiers in the measurement report (e.g., a beam measurement report) to the network entity 210 (e.g., omit the predicted measurement results, such as L1-RSRP/SINR, from the beam measurement report). Moreover, the techniques described herein provide a mechanisms for the UE 205 to report, based on the reporting parameters, its top K beam identifiers (e.g., the resource identifiers associated with the strongest predicted RSRP/SINR values from among the beams in the set), with K being a positive integer.

At 215, the network entity 210 may transmit or otherwise provide (and the UE 205 may receive or otherwise obtain) a signal indicating measurement reporting parameters (e.g., a CSI report setting) for the UE 205. The measurement reporting parameters may identify or otherwise indicate a set of beam prediction resources for a set of beams and a beam measurement report. The set of beam prediction resources may include a set of resource identifiers (e.g., CMR-IDs or other resource identifiers) identifying resources over which the UE 205 is to predict the channel performance using the beam associated with the resources identified by the resource identifier. The resource identifiers may be associated with multiple transmit beams of the network entity 210, with each resource identifier being associated with at least one beam. Each beam may be associated with one resource identifier or with multiple resource identifiers in the set of beam prediction resources.

In some examples, the measurement reporting parameters may include a reporting quantity that is used to signal to the UE 205 how may resource identifiers (e.g., a subset of beams in the set) are to be included in the beam measurement report. For example, the measurement reporting parameters may indicate the set of beam prediction resources (e.g., 24 resource identifiers, in one non-limiting example) as well as include the reporting quantity (reportQuantity) that identifies how many (e.g., four resource identifiers, in one non-limiting example) resource identifiers are to be included in the beam measurement report. This may enable the measurement reporting parameters to indicate to the UE 205 that the beam measurement report is to identify the top K (e.g., four, in this example) beams (via the associated resource identifiers) in the set of beams. The top K beams (e.g., the subset of beams, in this example) generally corresponds to, among the predicted measurement results for all beams (e.g., for all prediction resources) in the set, the best or highest predicted measurement results (e.g., those measurement results that satisfy a performance threshold). In some examples, more than the indicated reporting quantity (e.g., four in this example) may satisfy the performance threshold. However, the UE 205 may include the top four resource identifiers in the beam measurement report according to the reporting quantity.

An example of such reportQuantity configurations may include the strongest RSRP resources (StrongestResources-RSRP) indicating the top K resource identifiers, whose predicted L1-RSRPs are stronger than the predicted L1-RSRPs of the other resources in the prediction resource set associated with the CSI report setting. A StrongestResources-RSRP ordered indication (e.g., according to a beam measurement reporting scheme indicated in the measurement reporting parameters) may signal that the reported top K resource identifiers are provided in descending order according to their predicted L1-RSRP strength. A StrongestResources-RSRP non-ordered indication may signal that there is no ordering to be applied to the reported top-K resources (e.g., the reported resource identifiers are simply provided in a numerical order from lowest to highest index).

Another example of such reportQuantity configuration may include the strongest SINR resources (e.g., a StrongestResources-SINR parameter, information element, or set of parameters or information elements) indicating the top K resource identifiers whose predicted L1-SINRs are stronger than the predicted L1-SINRs of the other resources in the prediction resource set associated with the CSI report setting. A StrongestResources-SINR ordered indication may signal that the reported top K resources are provided in descending order according to their predicted L1-SINR strength. A StrongestResources-SINR non-ordered indication may signal that there is no ordering to be applied the reported top-K resources. Accordingly, the ordering scheme, as indicated in the beam measurement reporting scheme identified in the measurement reporting parameters may be applied to the indication of the resource identifiers in the beam measurement report.

The beam measurement reporting scheme identified by the measurement reporting parameters may generally define the format and/or content of the beam measurement report transmitted in response to the predictions of the UE 205. For example, the beam measurement reporting scheme may define the ordering of the reported results according to the ordering scheme. The ordering scheme may indicate whether or not the reported predicted measurement result are ordered in terms of highest or best beam to lowest or worst predicted performing beam among the subset of beams or are unordered (e.g., simply reported sequentially, lowest index to highest from among the beam prediction resources). The beam measurement reporting scheme may further define the content of the beam measurement report. The content may include or otherwise define how the resource identifiers are indicted in the beam measurement report (e.g., explicitly indicated resource identifiers, using a bitmap mapped to the prediction resource set, or in some other manner, such as using quantization techniques).

Accordingly, at 220 the UE 205 may transmit or otherwise provide (and the network entity 210 may receive or otherwise obtain) the beam measurement report. The beam measurement report may carry or otherwise convey an indication (or information identifying) of the resource identifiers associated with the subset of beams (e.g., the top K best performing beams from among the set of beams). The beams in the subset of beams may satisfy the performance threshold (e.g., a relative performance threshold, such as the top K beams in the set, and/or an absolute performance threshold, such as a threshold RSRP/SINR value). The resource identifiers associated with the subset of beams (e.g., based on the beams associated with the resource identifiers) may be indicated in the beam measurement report according to the beam measurement reporting scheme.

In some examples, the beam measurement and reporting techniques may be modified based, at least to some degree, on the confidence level associated with the predicted measurement results. Each predicted measurement result may have an associated confidence level. When the confidence level of the beams in the subset of beams is low (e.g., below or otherwise failing to satisfy a threshold and/or satisfying the threshold using older information), this may indicate that the beam measurement report is to include the resource identifiers, but not the predicted measurement results (e.g., the beam measurement reporting scheme). When the confidence level of the beams in the subset of beams is high (e.g., above or otherwise satisfying the threshold), this may indicate that the beam measurement report is to include both the resource identifiers and the predicted measurement results (e.g., a second beam measurement reporting scheme).

The UE 205 may be signaled to switch and/or request to switch between the first and second beam measurement reporting schemes. For example, the network entity 210 may transmit or otherwise provide (and the UE 205 may receive or otherwise obtain) a request for the UE 205 to switch to the second beam measurement reporting scheme. The request may be transmitted in a DCI, medium access control-control element (MAC-CE) and/or a RRC message. Similarly, the UE 205 may transmit a request to the network entity 210 requesting to switch from the beam measurement reporting scheme to the second beam measurement reporting scheme, or vice versa. The UE 205 may transmit its request in an uplink control information (UCI) message, a RRC message, and/or a MAC-CE message.

Accordingly, aspects of the techniques described herein provide for leveraging the reportQuantity to signal to the UE 205 to indicate the predicted top K beams (e.g., based on the predicted L1-RSRPs/L1-SINRs). The UE 205 may be configured with a CSI report setting, whose the reportQuantity (e.g., reporting quantity parameter or field) identifies a number of resource identifiers from the prediction resource set (e.g., the set of beam prediction resources) associated with the CSI report setting (e.g., the measurement reporting parameters). In some examples, the reporting quantity (reportQuantity) indicates, based on the CSI report setting, that such reported resource identifiers are associated with the predicted L1-RSRPs/L1-SINRs stronger than the remaining or other resources in the prediction resource set. When reporting such resource identifiers, they may or may not be ordered in ascending or descending order (e.g., according to their predicted L1-RSRP/L1-SINR strength). The beam prediction resources in the prediction resource set can be based on either actual CMR-ID or virtual resources that are not actually transmitted by network entity 210. The number of resource identifiers to be reported can be further configured by the CSI report setting.

Although the techniques discussed herein are described regarding UCI based prediction results reporting, it is to be understood that these techniques may be extended to MAC-CE based prediction reporting. That is, these techniques may be extended to the cases where a first CSI report setting corresponds to a first MAC-CE, while a second CSI report setting corresponds to a second MAC-CE. The network entity 210 may use RRC/MAC-CE/DCI signaling to control or otherwise manage aspects of the UE 205 with prediction result reporting through the first or the second MAC-CE. The UE 205 may report in the first and/or second MAC-CE, or through separate UCI/MAC-CE/RRC signaling, whether it would stop using or start using prediction result reporting in the first or second MAC-CE.

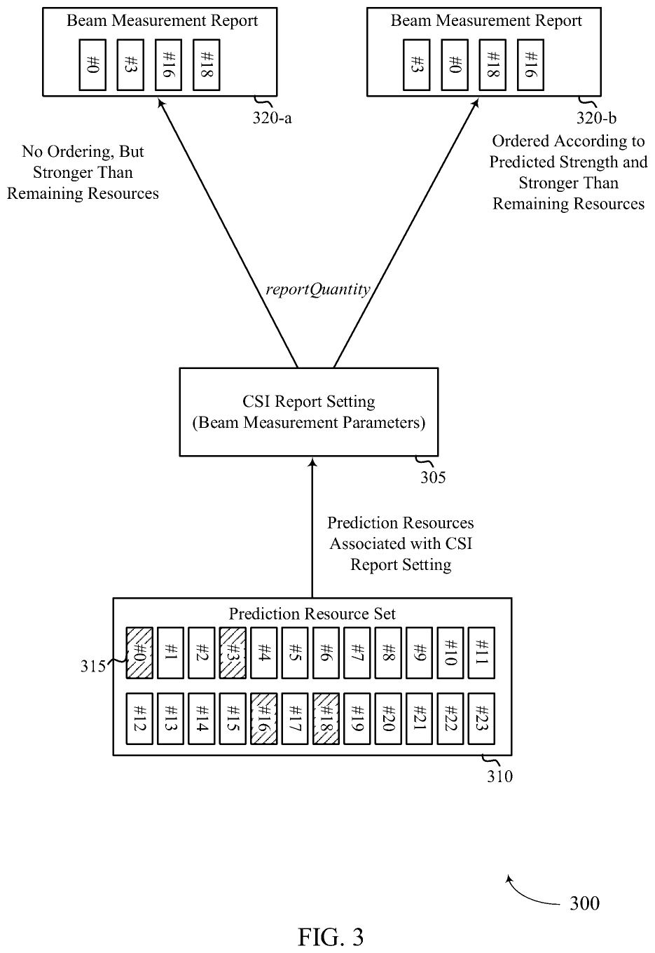

FIG. 3 illustrates an example of a reporting scheme 300 that supports indication of beam identifier in beam prediction reporting in accordance with one or more aspects of the present disclosure. Reporting scheme 300 may implement aspects of wireless communications system 100 and/or wireless communications system 200. Aspects of reporting scheme 300 may be implemented at or implemented by a UE and/or network entity, which may be examples of the corresponding devices described herein.

As discussed above, the techniques described herein provide a beam measurement and reporting scheme where resource identifiers for a subset of beams in a beam set are reported in beam measurement reporting. For example, a UE may receive a signal (e.g., RRC signal, MAC-CE signal, DCI signal, or other signaling means) that carries or otherwise conveys an indication of measurement reporting parameters (e.g., the CSI report setting 305) for the UE. The measurement reporting parameters may indicate or otherwise identify a set of beam prediction resources (e.g., prediction resource set 310) for a set of beams (transmit beams of the network entity that are associated with resources corresponding to the resource identifier). That is, the prediction resource set 310 may identify a set of beam prediction resources (with only one beam prediction resource 315, corresponding to the resource identifier of the beam prediction resource 315, in the set of beam prediction resources being labeled by way of example), with each resource identifier for the beam prediction resources in the prediction resource set 310 may be associated with a beam, such as a transmit beam, of the network entity.

The measurement reporting parameters may indicate a reporting quantity (reportQuantity) that identifies, at least to some degree, the number of resource identifiers to be indicated in a beam measurement report 320. That is, although the prediction resource set 310 may include 24 resource identifiers, in this non-limiting example, the reporting configuration may indicate to the UE to report its top K (reportQuantity) beams (e.g., resource identifiers associated with a subset of beams in the beam set) in the beam measurement report 320. That is, the UE may predict the measurement results (e.g., L1-RSRP/SINR) for some or all of the resources (e.g., associated with beams) of resource identifiers, but only report the top K (e.g., as indicated by the reporting quantity) resource identifiers (e.g., a subset of beams) in the beam measurement report 320. The subset of beams may generally correspond to the beams (e.g., resource identifiers associated with beams) having the highest predicted RSRP/SINR from among the other beams (e.g., resource identifiers) in the prediction resource set 310. The beams in the subset of beams may be considered beams that satisfy a performance threshold (e.g., the highest or top K performing beams). The performance threshold may be based on the predicted RSRP and/or SINR of each beam in the subset of beams being higher than the RSRP and/or SINR of the remaining beams in the set of beams. In the non-liming example illustrated in FIG. 3, the top K beams (e.g., the subset of beam) correspond to the beams associated with resource identifiers #0, #3, #16, and #18 (e.g., K=4 where four resource identifiers are indicated by the reporting quantity). Accordingly, the UE may transmit the beam measurement report 320 indicating the resource identifiers associated with the subset of beams (with each beam in the subset satisfying the performance threshold for the corresponding beam prediction resource).

In some aspects, the resource identifiers of the beams in the subset indicated in the beam measurement report 320 may be based on a beam measurement reporting scheme. The beam measurement reporting scheme may indicate whether the resource identifiers are indicated in the beam measurement report 320 or both the resource identifiers and the predicted measurement result (e.g., L1-RSRP/SINR) are indicated in the beam measurement report 320. In the non-limiting example illustrated in FIG. 3, the beam measurement reporting scheme indicates that the resource identifiers, but not the predicted measurement results, are indicted in the beam measurement report 320. As discussed above, a confidence level associated with each predicted measurement result may be used to switch the UE between this beam measurement reporting scheme (only resource identifiers being reported) to a second beam measurement reporting scheme (reporting both resource identifiers and the predicted measurement results).

As also illustrated in the non-limiting example of FIG. 3, in some examples the beam measurement reporting scheme used for the beam measurement report 320 (as indicated by the CSI report setting 305) may be associated with an ordering scheme that broadly defines aspects of how the resource identifiers are indicated in the beam measurement report 320. For example, the ordering scheme applied to the beam measurement report 320 may define in which order the resource identifiers are indicated and/or how such resource identifiers are to be indicated (e.g., using an explicit indication, as shown in FIG. 3, using a bitmap, or using some other indication technique).

For example, beam measurement report 320-a illustrates an example where the resource identifiers (e.g., each resource identifier) are indicated according to the ordering scheme in a nonordered manner, such as a sequential manner (e.g., without ordering from highest or best beam to lowest). In this approach, the beam measurement report 320-a may indicate the resource identifiers of the top K beams (as defined by the predicted measurement result and the reporting quantity) in the same sequence or order as were indicated in the prediction resource set 310 (e.g., resource identifier #0 first, then resource identifier #3 next, followed by resource identifiers #16 and #18). This approach may be considered the easiest to implement as the UE simply reports the resource identifiers of the top K beams. This may indicate to the network entity that the reported beams are the strongest (e.g., highest or best predicted L1-RSRP/SINR) among the beam set (e.g., from the prediction resource set 310).

Beam measurement report 320-b illustrates an example where the resource identifiers are indicated according to the order scheme in an ordered manner (e.g., with the reported resource identifiers being indicated in order of strongest beam first, followed by next strongest beam, and so forth, for the beams in the subset of beams). This scheme provides an indication of the four (in this example) top performing beams in the beam set and also informs the network entity which beams among the four are the strongest beams (e.g., associated with the highest L1-RSRP/SINR first, the next highest L1-RSRP/SINR, and so forth, for the subset of beams).

Accordingly, reporting scheme 300 illustrates a non-limiting example where the UE predicts the L1-RSRP/SINR for the resources (and associated beams) in the prediction resource set 310, but reports only the top K beams in the beam measurement report 320. The top K beam may be reported sequentially (e.g., nonordered) or in an ordered manner from best to worst predicted performing beam.

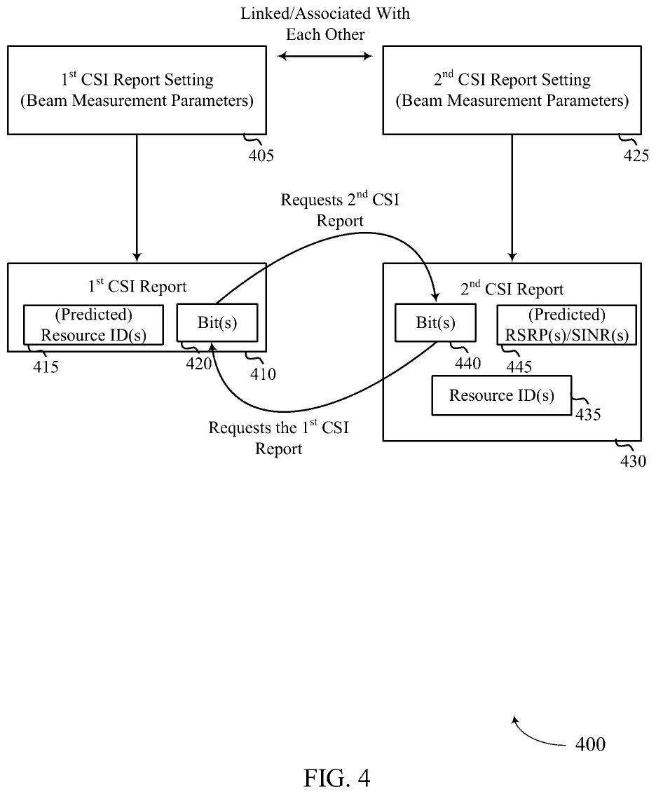

FIG. 4 illustrates an example of a reporting scheme 400 that supports indication of beam identifier in beam prediction reporting in accordance with one or more aspects of the present disclosure. Reporting scheme 400 may implement aspects of wireless communications system 100 and/or wireless communications system 200 and/or aspects of reporting scheme 300. Aspects of reporting scheme 400 may be implemented at or implemented by a UE and/or network entity, which may be examples of the corresponding devices described herein.

As discussed above, the techniques described herein provide a beam reporting scheme where resource identifiers for a subset of beams in a beam set are reported in beam measurement reporting. For example, a UE may receive a signal (e.g., RRC signal, MAC-CE signal, DCI signal, or other signaling means) that carries or otherwise conveys an indication of measurement reporting parameters (e.g., a first CSI report setting 405) for the UE. The measurement reporting parameters may indicate or otherwise identify a set of beam prediction resources for a set of beams. That is, the prediction resource set may identify a set of beam prediction resources, with each resource identifier for the beam prediction resources in the prediction resource set may be associated with a beam, such as a transmit beam, of the network entity.

The measurement reporting parameters may indicate a reporting quantity (e.g., a reportQuantity information element or parameter) that identifies, at least to some degree, the number of resource identifiers 415 to be indicated in a first beam measurement report 410. The UE may predict the measurement results (e.g., L1-RSRP/SINR) for some or all of the resources (e.g., associated with beams) of the resource identifiers in the beam prediction set, but only report the top K (e.g., as indicated by the reporting quantity) resource identifiers 415 (e.g., a subset of beams) in the first beam measurement report 410.

The subset of beams may generally correspond to the beams (e.g., resource identifiers associated with beams) having the highest predicted RSRP/SINR from among the other beams (e.g., resource identifiers) in the prediction resource set. The beams in the subset of beams may be considered beams that satisfy a performance threshold (e.g., the highest or top K performing beams). The performance threshold may be based on the predicted RSRP and/or SINR of each beam in the subset of beams being higher than the RSRP and/or SINR of the remaining beams in the set of beams. Accordingly, the UE may transmit the first beam measurement report 410 indicating the resource identifiers 415 associated with the subset of beams (with each beam in the subset satisfying the performance threshold for the corresponding beam prediction resource).

In some aspects, the resource identifiers of the beams in the subset indicated in the first beam measurement report 410 may be based on a beam measurement reporting scheme. The beam measurement reporting scheme may indicate the content (e.g., what the information is to be reported).

In the non-limiting example illustrated in FIG. 4, the beam measurement reporting scheme may also include bit(s), field(s), or other parameter(s) that signals that the UE is recommending switching to the second beam measurement reporting scheme (e.g., where both the resource identifiers and the predicted measurement results are reported). As discussed above, the network and/or UE may signal to switch between resource identifier only or resource identifier and predicted measurement result reporting. Although the description below relates to the UE requesting to switch to the second beam measurement reporting scheme, it is to be understood that the network entity may also request that the UE switch to the second scheme using these techniques.

Accordingly, reporting scheme 400 illustrates an example where the UE sets a first field (e.g., bit(s) 420) in the beam measurement report (e.g., the first beam measurement report 410, in this example) to indicate transmission of a second beam measurement report 430 according to second measurement reporting parameters (e.g., according to the second CSI report setting 425). The second CSI report setting 425 may also identify a second beam measurement reporting scheme to be applied when transmitting the second beam measurement report 430. The second beam measurement reporting scheme in the second CSI report setting 425 may be different from the beam measurement reporting scheme indicated in the first CSI report setting 405 in that both the resource identifiers 435 and the predicted measurement results 445 (e.g., the L1-RSRP/SINR values) are indicated in the second beam measurement report 430. In some examples, the set of beam prediction resources indicated in the first CSI report setting 405 may be the same or similar (e.g., adjacent in the frequency or spatial domain and/or recent in the time domain) resources as are indicated in the second CSI report setting 425 (e.g., a second set of beam prediction resources).

Setting the bit(s) 420 in the first beam measurement report 410 may signal to the network that the UE recommends switching from the current beam measurement reporting scheme (e.g., resource identifiers only reporting) to the second beam measurement reporting scheme (both resource identifiers and predicted measurement results), or vice versa. In response, the UE may be further configured with the second CSI report setting 425 in which a reporting quantity (reportQuantity) includes both predicted L1-RSRP/SINRs of a number of resources in the prediction resource set associated with the second CSI report setting 425 and the resource identifiers associated with the number of resources. The first CSI report setting 405 and the second CSI report setting 425 may be linked or otherwise associated with each other. For example, a CSI report setting identifier in the first CSI report setting 405 may be configured (e.g., indicated) in the second CSI report setting 425. In another example, the CSI report setting identifier in the second CSI report setting 425 may be configured in the first CSI report setting 405.

Accordingly, the UE may recommend whether to switch between the top K beams being reported (e.g., resource identifiers only reporting) and top K beams as well as the predicted measurement results being reported. The UE may transmit or otherwise provide (and the network entity may receive or otherwise obtain) the second beam measurement report 430 according to the second beam measurement reporting scheme. The second beam measurement report 430 may indicate both the resource identifiers 435 for a second subset of beam identifiers as well as the predicted measurement results 445.

The resource identifiers 435 reported in the second beam measurement report 430 may be the same or different beams (e.g., resource identifiers 415) indicated in the first beam measurement report 410. In some examples, the prediction resource set associated with the second CSI report setting 425 may be the same as the prediction resource set associated with the first CSI report setting 405. In some examples, the CMR set associated with the second CSI report setting 425 may be the same as the CMR set associated with the first CSI report setting 405.

In some examples, UCI based signaling may be used to request switching between beam measurement reporting schemes (e.g., between the first CSI report setting 405 and the second CSI report setting 425). In this UCI approach, the first beam measurement report 410 (transmitted in a UCI) and the second beam measurement report 430 both include bit(s), field(s), or parameter(s) indicating whether a switch is being requested. For example, a first field (e.g., bit(s) 420) may be included in the first beam measurement report 410 and a second field (e.g., bit(s) 440) may be included in the second beam measurement report 430 that indicates the UE's recommendations on whether to switch to the alternatively linked CSI report setting. In some examples, this may include one additional bit being added to the reporting quantity, which may be toggled to convey the indication (e.g., toggled from 1-to-0, or vice versa) of a request to switch.

In some examples, MAC-CE and/or RRC based signaling may be used to request switching between beam measurement reporting schemes (e.g., between the first CSI report setting 405 and the second CSI report setting 425). In this example, the request to switch may be signaled in MAC-CE and/or RRC signaling from the UE. The MAC-CE and/or RRC signaling may carry the beam measurement reports or the beam measurement reports may be carried in a UCI, with the request to switch being signaled separately in the MAC-CE and/or RRC signaling.

In some aspects, criteria (e.g., threshold(s)) may be established by which the UE determines whether or not to switch between the beam measurement reporting schemes (e.g., to determine whether to set the bit(s)). In some examples, the determination may be based on UE capability reporting. For example, the UE may transmit a UE capability report to the network entity that indicates which beam measurement reporting scheme (e.g., which CSI report setting) the UE supports performing. The UE capability report may indicate whether the UE supports one or both of the resource identifier only beam measurement reporting scheme and the resource identifier and predicted measurement result beam measurement reporting scheme. In some examples, the criteria may be (pre) configured by the network. In some examples, the criteria may be (pre) configured by the network entity for the UE.

In another example, the criteria may be based on the confidence level associated with the predicted measurement results. A low confidence level may indicate that, to improve efficiency, the resource identifier beam measurement reporting scheme is to be used for beam measurement reports. Conversely, a high confidence level may indicate that, also to improve efficiency, the resource identifier plus predicted measurement results beam measurement reporting scheme is to be used for beam measurement reports.

Accordingly, reporting scheme 400 illustrates a non-limiting example where the UE and/or network entity may request a switch between the beam measurement reporting schemes. This may include setting bit(s), flag(s), field(s), and/or parameter(s) in the CSI reports (or using separate signaling) that signals whether the UE wants to switch between CSI report settings. The UE may set bit(s) 420 in the first CSI report (e.g., the first beam measurement report 410) that indicates (e.g., requests) to switch to the second CSI report setting 425 where both resource identifiers 435 and predicted measurement results 445 are to be reported. The UE may set bit(s) 440 in the second CSI report (e.g., the second beam measurement report 430) that indicates (e.g., requests) to switch to the first CSI report setting 405 where the resource identifiers 415 are reported.

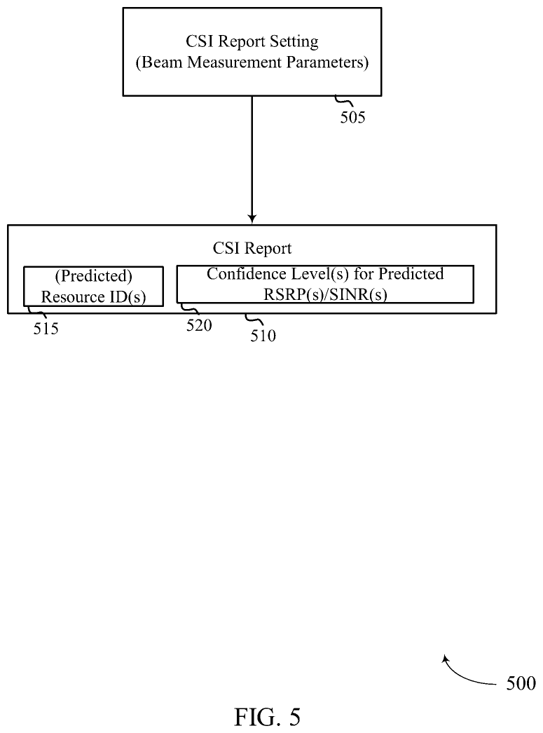

FIG. 5 illustrates an example of a reporting scheme 500 that supports indication of beam identifier in beam prediction reporting in accordance with one or more aspects of the present disclosure. Reporting scheme 500 may implement aspects of wireless communications system 100 and/or wireless communications system 200 and/or aspects of reporting scheme 300 and/or reporting scheme 400. Aspects of reporting scheme 500 may be implemented at or implemented by a UE and/or network entity, which may be examples of the corresponding devices described herein.

As discussed above, the techniques described herein provide a beam reporting scheme where resource identifiers for a subset of beams in a beam set are reported in beam measurement reporting. For example, a UE may receive a signal (e.g., RRC signal, MAC-CE signal, DCI signal, or other signaling means) that carries or otherwise conveys an indication of measurement reporting parameters (e.g., a CSI report setting 505) for the UE. The measurement reporting parameters may indicate or otherwise identify a set of beam prediction resources for a set of beams. That is, the prediction resource set may identify a set of beam prediction resources, with each resource identifier for the beam prediction resources in the prediction resource set may be associated with a beam, such as a transmit beam, of the network entity.

The measurement reporting parameters may indicate a reporting quantity (reportQuantity) that identifies, at least to some degree, the number of resource identifiers 515 to be indicated in a beam measurement report 510 (e.g., a CSI report). The UE may predict the measurement results (e.g., L1-RSRP/SINR) for some or all of the resources (e.g., associated with beams) of the resource identifiers in the beam prediction set, but only report the top K (e.g., as indicated by the reporting quantity) resource identifiers 515 (e.g., a subset of beams) in the beam measurement report 510.

The subset of beams may generally correspond to the beams (e.g., resource identifiers associated with beams) having the highest predicted RSRP/SINR from among the other beams (e.g., resource identifiers) in the prediction resource set. The beams in the subset of beams may be considered beams that satisfy a performance threshold (e.g., the highest or top K performing beams). The performance threshold may be based on the predicted RSRP and/or SINR of each beam in the subset of beams being higher than the RSRP and/or SINR of the remaining beams in the set of beams. Accordingly, the UE may transmit the beam measurement report 510 indicating the resource identifiers 515 associated with the subset of beams (with each beam in the subset satisfying the performance threshold for the corresponding beam prediction resource).

In some aspects, the resource identifiers of the beams in the subset indicated in the beam measurement report 510 may be based on a beam measurement reporting scheme. The beam measurement reporting scheme may indicate the content (e.g., what the information is to be reported). In the non-limiting example illustrated in FIG. 5, the beam measurement reporting scheme may also include the UE including or otherwise indicating confidence levels 520 associated with the predicted L1-RSRP/SINR levels. This mechanism may, in some examples, serve to allow the network entity to manage aspects of switching between the beam measurement reporting scheme where resource identifiers 515 are reported or both the resource identifiers 515 and the predicted measurement results are reported.

In some aspects, this may include the reporting quantity (reportQuantity) indicated in the CSI report setting 505 indicating that the UE is to include the confidence levels 520 in the beam measurement report 510. The UE may identify or otherwise determine the confidence level associated with some or all (e.g., each) predicted measurement result and include an indication of the confidence level in the CSI report. In some examples, this may include reporting the confidence level of the strongest predicted L1-RSRP/SINR in the reported in the CSI report (e.g., one confidence level is reported, which is the confidence level for the highest or top K beam among the subset of beams reported in the CSI report according to the reported resource identifiers). In some examples, this may include reporting the confidence level of each reported resource identifier in the CSI report (e.g., K confidence levels are reported, which are the confidence level for the each beam in the subset of beams reported in the CSI report via the resource identifier). In some examples, the confidence levels 520 reported in the CSI report may use quantization techniques to reduce or minimize the number of bits used to convey the indication.

Accordingly, the network entity may use the confidence levels 520 indicated in the CSI report to determine whether to switch between the resource identifier reporting scheme and the resource identifier plus predicted measurement result reporting scheme.

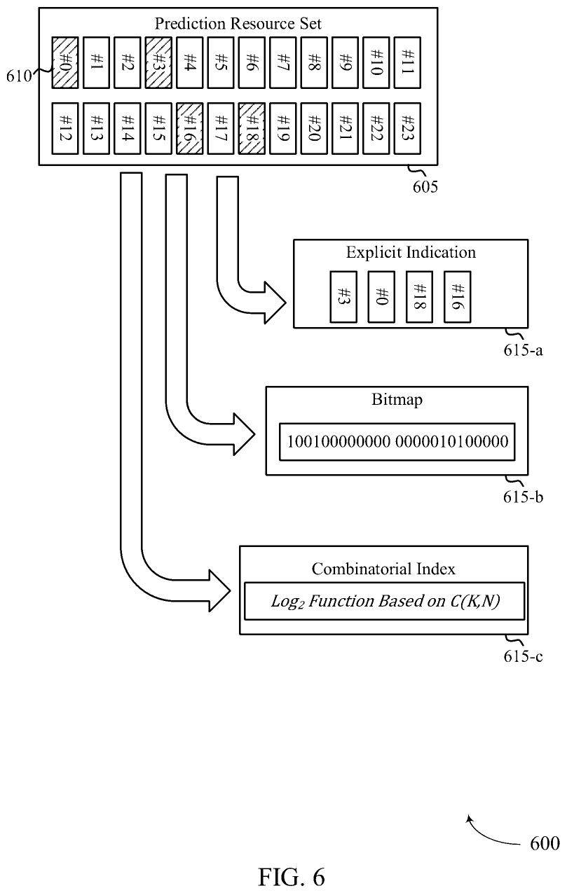

FIG. 6 illustrates an example of a reporting scheme 600 that supports indication of beam identifier in beam prediction reporting in accordance with one or more aspects of the present disclosure. Reporting scheme 600 may implement aspects of wireless communications system 100 and/or wireless communications system 200 and/or aspects of reporting scheme 300, reporting scheme 400 and/or reporting scheme 500. Aspects of reporting scheme 600 may be implemented at or implemented by a UE and/or network entity, which may be examples of the corresponding devices described herein.

As discussed above, the techniques described herein provide a beam reporting scheme where resource identifiers 610 for a subset of beams in a beam set are reported in beam measurement reporting. For example, a UE may receive a signal (e.g., RRC signal, MAC-CE signal, DCI signal, or other signaling means) that carries or otherwise conveys an indication of measurement reporting parameters (e.g., a CSI report setting) for the UE. The measurement reporting parameters may indicate or otherwise identify a set of beam prediction resources (e.g., resource identifiers 610) for a set of beams. That is, the prediction resource set may identify a set of beam prediction resources (e.g., resource identifiers 610), with each resource identifier for the beam prediction resources in the prediction resource set 605 may be associated with a beam, such as a transmit beam, of the network entity.

The measurement reporting parameters may indicate a reporting quantity (reportQuantity) that identifies, at least to some degree, the number of resource identifiers 610 to be indicated in a beam measurement report 615 (e.g., a CSI report). The UE may predict the measurement results (e.g., L1-RSRP/SINR) for some or all of the resources (e.g., associated with beams) of the resource identifiers 610 in the beam prediction set, but only report the top K (e.g., as indicated by the reporting quantity) resource identifiers 610 (e.g., a subset of beams) in the beam measurement report 615. In the non-limiting example illustrated in FIG. 6, the top K beams (e.g., the subset of beams) correspond to four resource identifiers 610 (K=4), with the best predicted measurement results corresponding to resource identifiers #0, #3, #16, and #18.

The subset of beams may generally correspond to the beams (e.g., resource identifiers 610 associated with beams) having the highest predicted RSRP/SINR from among the other beams (e.g., resource identifiers) in the prediction resource set 605. The beams in the subset of beams may be considered beams that satisfy a performance threshold (e.g., the highest or top K performing beams). The performance threshold may be based on the predicted RSRP and/or SINR of each beam in the subset of beams being higher than the RSRP and/or SINR of the remaining beams in the set of beams. Accordingly, the UE may transmit the beam measurement report 615 indicating the resource identifiers associated with the subset of beams (with each beam in the subset satisfying the performance threshold for the corresponding beam prediction resource).

In some aspects, the resource identifiers of the beams in the subset indicated in the beam measurement report 615 may be based on a beam measurement reporting scheme. The beam measurement reporting scheme may indicate the content (e.g., what the information is to be reported). In the non-limiting example illustrated in FIG. 6, the beam measurement reporting scheme may include or otherwise indicate an ordering scheme applied to the indication of the resource identifiers indicated in the beam measurement report 615. In particular, three ordering scheme examples are illustrated in FIG. 6 by was of example only.

In some examples, the ordering scheme may be an unordered ordering scheme in that the resource identifiers 610 reported in the CSI report are not ordered according to the predicted measurement result strength or quality. For example, the resource identifiers may be reported according to their associated resource identifier (e.g., from lowest resource identifier, such as #0, to highest resource identifier, such as #18, in this example). In other examples, the ordering scheme may be an ordered ordering scheme in that the resource identifiers 610 reported in the CSI report are ordered according to the predicted measurement result strength or quality.

For the CSI report setting and depending on whether the reported resources are ordered according to their predicted L1-RSRP/SINR values, different reporting frameworks may be applied to the CSI report. For example, beam measurement report 615-a illustrates an example were the resource identifiers 610 are explicitly reported. The explicitly reported resource identifiers 610 may be ordered or unordered (e.g., according to an ordering scheme). The number of bits used to report a resource identifier may based, at least to some degree, on the total number of bits in the prediction resource set associated with the CSI report (e.g., [log₂ N], where N is the total number of resources in the prediction resource set.

Beam measurement report 615-b illustrates an example where the resource identifiers 610 are reported using a bitmap. The prediction resource set may identify a number of prediction resources (e.g., N=24 resource identifiers, in this example), where each bit in the bitmap may correspond to a prediction resource in the set. Setting a bit to 1 may indicate that the corresponding resource identifier (e.g., the beam associated with the resources associated with the resource identifier) is included in the subset of beams and setting the bit to 0 may indicate that the corresponding resource identifier is not included in the subset of beams. That is, beam measurement report 615-b uses a bitmap where each bit corresponds to a certain resource in the prediction resource set associated with the CSI report setting (i.e., a length-N bitmap, wherein N is the total number of resources in the prediction resource set).

Beam measurement report 615-c illustrates an example where a combinatorial index is used to convey the indication of the resource identifiers in the CSI report. The combinatorial index may be based, at least to some degree, on the number of beams in the beam prediction resources (e.g., the number of prediction resources in the prediction resource set, which is N and N=24 in this example) as well as the number of beams in the subset of beams (e.g., the number of resource identifiers reported in the CSI report, which may be K and K=4 in this example). For example, a

$${C}_{N}^{K}$$

combinatorial index (e.g., via

$$[ {log}_{2} {C}_{N}^{K} ] )$$

associated with the reported resources and the prediction resource set may be applied for beam measurement report 615-c. In the example where N=24 and K=4, this approach may use 14 bits to convey the indication the resource identifiers in the CSI report.

In some aspects, determining which approach to employ for beam measurement report 615 may be based on the values of N and K. For example, the UE may consider each option (e.g., explicitly reported, bitmap, or combinatorial index) depending on the number of resources included in the prediction resource set (e.g., N) as well as the number (e.g., K) of beams to be reported in the CSI report to determine which option uses the fewest number of bits and select that option. Moreover, which approach to employ may be based on other information to be indicated in the CSI report, such as whether the reporting quantity indicates to report confidence levels.

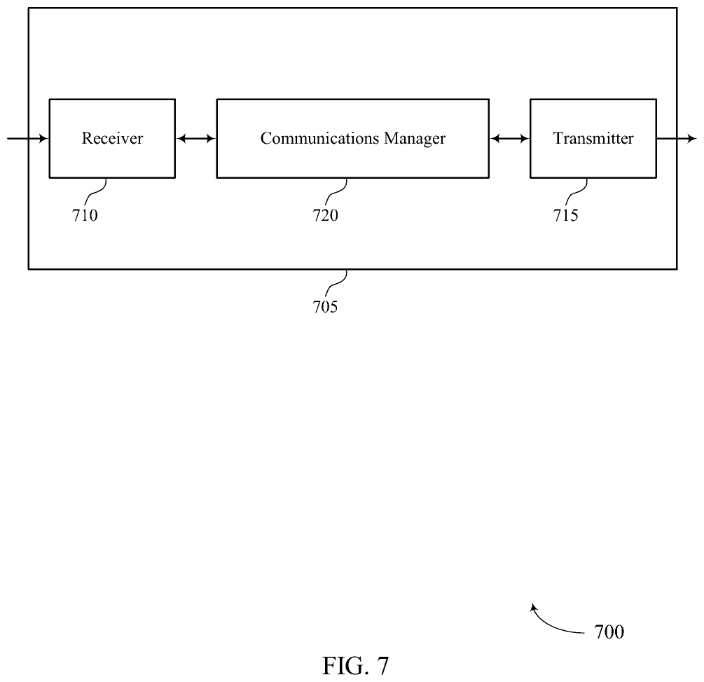

FIG. 7 illustrates a block diagram 700 of a device 705 that supports indication of beam identifier in beam prediction reporting in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to indication of beam identifier in beam prediction reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to indication of beam identifier in beam prediction reporting). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of indication of beam identifier in beam prediction reporting as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving a signal indicating measurement reporting parameters for the UE, the measurement reporting parameters identifying a set of beam prediction resources for a set of beams and a beam measurement reporting scheme. The communications manager 720 may be configured as or otherwise support a means for transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for improved flexibility and efficiency in prediction results reporting using beam prediction reporting schemes where the UE reports the resource identifiers for the top K beams in the prediction resource set or reports both the resource identifiers as well as the predicted measurement results in the prediction results reporting.

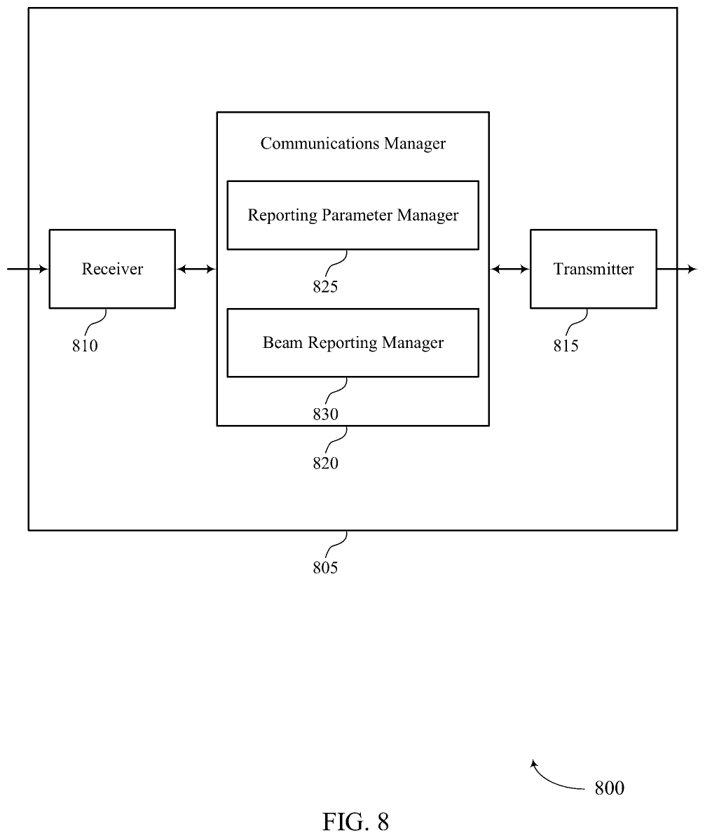

FIG. 8 illustrates a block diagram 800 of a device 805 that supports indication of beam identifier in beam prediction reporting in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to indication of beam identifier in beam prediction reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to indication of beam identifier in beam prediction reporting). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of indication of beam identifier in beam prediction reporting as described herein. For example, the communications manager 820 may include a reporting parameter manager 825 a beam reporting manager 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The reporting parameter manager 825 may be configured as or otherwise support a means for receiving a signal indicating measurement reporting parameters for the UE, the measurement reporting parameters identifying a set of beam prediction resources for a set of beams and a beam measurement reporting scheme. The beam reporting manager 830 may be configured as or otherwise support a means for transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

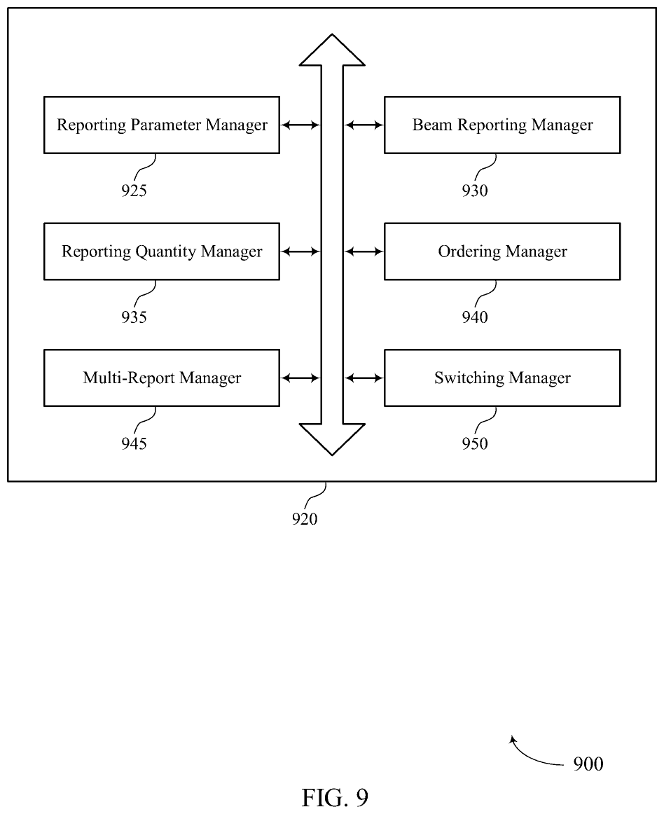

FIG. 9 illustrates a block diagram 900 of a communications manager 920 that supports indication of beam identifier in beam prediction reporting in accordance with one or more aspects of the present disclosure. The communications manager 920 may be an example of aspects of a communications manager 720, a communications manager 820, or both, as described herein. The communications manager 920, or various components thereof, may be an example of means for performing various aspects of indication of beam identifier in beam prediction reporting as described herein. For example, the communications manager 920 may include a reporting parameter manager 925, a beam reporting manager 930, a reporting quantity manager 935, an ordering manager 940, a multi-report manager 945, a switching manager 950, or any combination thereof. Each of these components may communicate, directly or indirectly, with one another (e.g., via one or more buses).

The communications manager 920 may support wireless communication at a UE in accordance with examples as disclosed herein. The reporting parameter manager 925 may be configured as or otherwise support a means for receiving a signal indicating measurement reporting parameters for the UE, the measurement reporting parameters identifying a set of beam prediction resources for a set of beams and a beam measurement reporting scheme. The beam reporting manager 930 may be configured as or otherwise support a means for transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

In some examples, the reporting quantity manager 935 may be configured as or otherwise support a means for receiving, as one of the measurement reporting parameters, a reporting quantity indicating a number of resource identifiers to be indicated in the beam measurement report, where the subset of beams is based on beams satisfying the performance threshold and the reporting quantity. In some examples, the performance threshold is based on a predicted RSRP, a predicted SINR, or both, of each beam in the subset of beams being higher than the RSRP, SINR, or both, of remaining beams in the set of beams.

In some examples, the ordering manager 940 may be configured as or otherwise support a means for applying, based on the beam measurement reporting scheme, an ordering scheme to the indication of the resource identifiers in the beam measurement report. In some examples, according to the ordering scheme each resource identifier is ordered within the beam measurement report according to a predicted beam measurement result associated with each beam in the subset of beams. In some examples, the ordering scheme defines a bitmap associated with the set of beam prediction resources. In some examples, each bit in the bitmap corresponds to a beam in the set of beams, with each bit being set to indicate that the beam is included in the subset of beams. In some examples, the ordering scheme defines a combinatorial index based on a first number of beam prediction resources in the set of beam prediction resources and second number of beams in the subset of beams.

In some examples, the multi-report manager 945 may be configured as or otherwise support a means for setting a first field in the beam measurement report to indicate transmission of a second beam measurement report according to second measurement reporting parameters identifying a second beam measurement reporting scheme. In some examples, the multi-report manager 945 may be configured as or otherwise support a means for transmitting, according to the second beam measurement reporting scheme, the second beam measurement report indicating resource identifiers associated with a second subset of beams from a second set of beams and a predicted measurement result for each beam in the second subset of beams, the second beam measurement report further including a second field associating the second beam measurement report with the beam measurement report. In some examples, the set of beam prediction resources and a second set of beam prediction resources identified by the second beam measurement reporting parameters include a same resource set.

In some examples, the switching manager 950 may be configured as or otherwise support a means for transmitting a request to switch from the beam measurement reporting scheme to a second beam measurement reporting scheme, the second beam measurement reporting scheme associated with second measurement reporting parameters identifying a second set of beam prediction resources. In some examples, an UCI message, a MAC-CE, an RRC message, or a combination thereof.

In some examples, the switching manager 950 may be configured as or otherwise support a means for receiving a request to switch to a second beam measurement reporting scheme based on a confidence level, the confidence level associated with each beam in the subset of beams satisfying the performance threshold. In some examples, the beam measurement report is received in one or more of an UCI message, an RRC message, a MAC-CE, or a combination thereof, and a second beam measurement report associated with the beam measurement report is transmitted in a second UCI message, a second RRC message, a second MAC-CE, or a combination thereof.

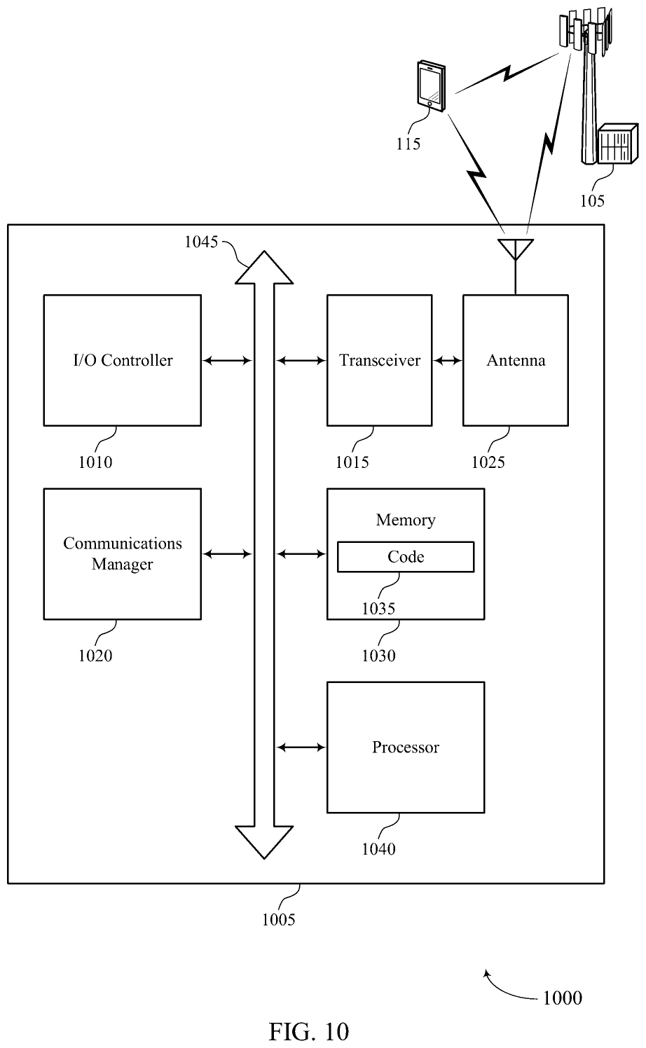

FIG. 10 illustrates a diagram of a system 1000 including a device 1005 that supports indication of beam identifier in beam prediction reporting in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting indication of beam identifier in beam prediction reporting). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving a signal indicating measurement reporting parameters for the UE, the measurement reporting parameters identifying a set of beam prediction resources for a set of beams and a beam measurement reporting scheme. The communications manager 1020 may be configured as or otherwise support a means for transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

By including or configuring the communications manager 1020 in accordance with examples as described herein, the device 1005 may support techniques for improved flexibility and efficiency in prediction results reporting using beam prediction reporting schemes where the UE reports the resource identifiers for the top K beams in the prediction resource set or reports both the resource identifiers as well as the predicted measurement results in the prediction results reporting.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of indication of beam identifier in beam prediction reporting as described herein, or the processor 1040 and the memory 1030 may be otherwise configured to perform or support such operations.

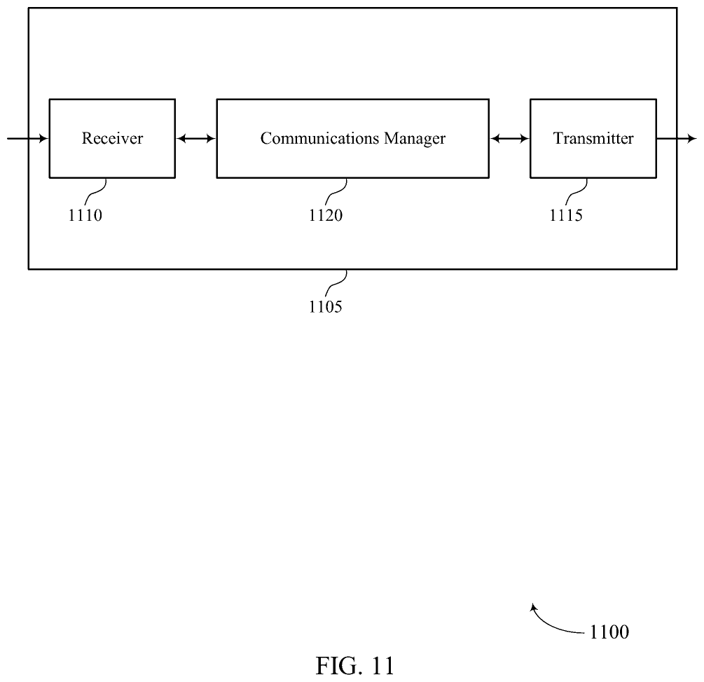

FIG. 11 illustrates a block diagram 1100 of a device 1105 that supports indication of beam identifier in beam prediction reporting in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of indication of beam identifier in beam prediction reporting as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting, to a UE, a signal indicating measurement reporting parameters for the UE, the measurement reporting parameters identifying a set of beam prediction resources for a set of beams and a beam measurement reporting scheme. The communications manager 1120 may be configured as or otherwise support a means for receiving, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for improved flexibility and efficiency in prediction results reporting using beam prediction reporting schemes where the UE reports the resource identifiers for the top K beams in the prediction resource set or reports both the resource identifiers as well as the predicted measurement results in the prediction results reporting.

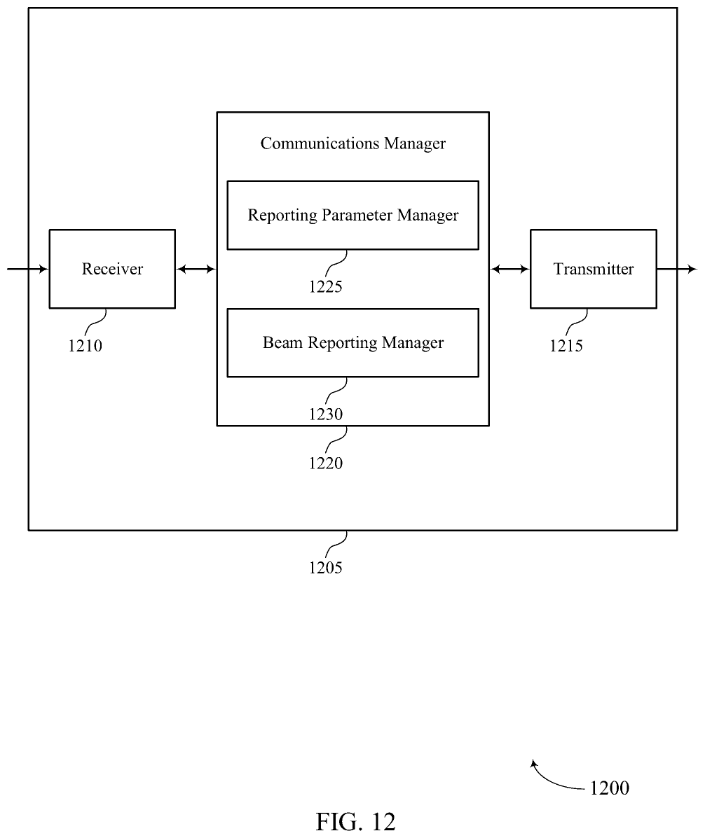

FIG. 12 illustrates a block diagram 1200 of a device 1205 that supports indication of beam identifier in beam prediction reporting in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of indication of beam identifier in beam prediction reporting as described herein. For example, the communications manager 1220 may include a reporting parameter manager 1225 a beam reporting manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The reporting parameter manager 1225 may be configured as or otherwise support a means for transmitting, to a UE, a signal indicating measurement reporting parameters for the UE, the measurement reporting parameters identifying a set of beam prediction resources for a set of beams and a beam measurement reporting scheme. The beam reporting manager 1230 may be configured as or otherwise support a means for receiving, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

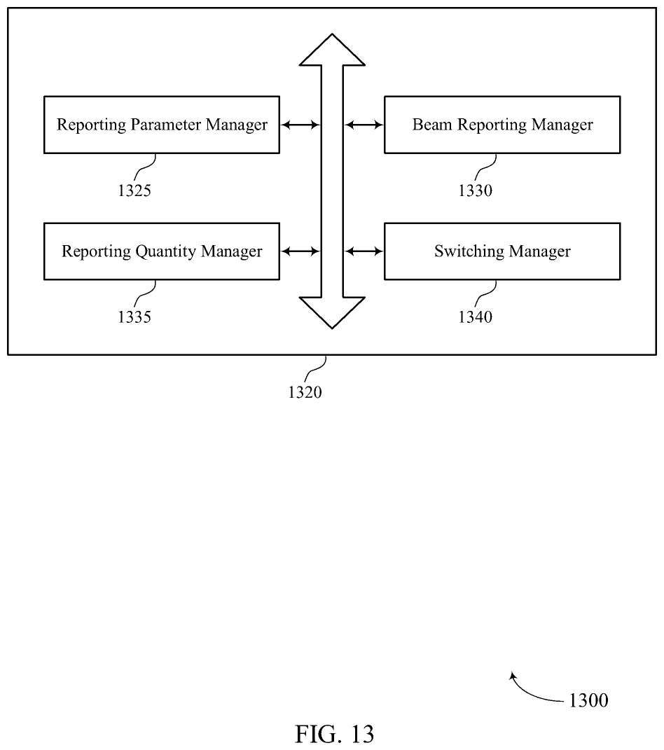

FIG. 13 illustrates a block diagram 1300 of a communications manager 1320 that supports indication of beam identifier in beam prediction reporting in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of indication of beam identifier in beam prediction reporting as described herein. For example, the communications manager 1320 may include a reporting parameter manager 1325, a beam reporting manager 1330, a reporting quantity manager 1335, a switching manager 1340, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The reporting parameter manager 1325 may be configured as or otherwise support a means for transmitting, to a UE, a signal indicating measurement reporting parameters for the UE, the measurement reporting parameters identifying a set of beam prediction resources for a set of beams and a beam measurement reporting scheme. The beam reporting manager 1330 may be configured as or otherwise support a means for receiving, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

In some examples, the reporting quantity manager 1335 may be configured as or otherwise support a means for transmitting, as one of the measurement reporting parameters, a reporting quantity a number of resource identifiers to be indicated in the beam measurement report, where the subset of beams is based on the beams satisfying the performance threshold and the reporting quantity.

In some examples, the reporting quantity manager 1335 may be configured as or otherwise support a means for identifying a first field in the beam measurement report that indicates transmission of a second beam measurement report from the UE according to second measurement reporting parameters identifying a second beam measurement reporting scheme. In some examples, the reporting quantity manager 1335 may be configured as or otherwise support a means for receiving, according to the second beam measurement reporting scheme, the second beam measurement report indicating resource identifiers associated with a second subset of beams from a second set of beams and a predicted measurement result for each beam in the second subset of beams, the second beam measurement report further including a second field associating the second beam measurement report with the beam measurement report. In some examples, the set of beam prediction resources and a second set of beam prediction resources identified by the second beam measurement reporting parameters include a same resource set.

In some examples, the switching manager 1340 may be configured as or otherwise support a means for transmitting, to the UE, a request to switch from the beam measurement reporting scheme to a second beam measurement reporting scheme, the second beam measurement reporting scheme associated with second measurement reporting parameters identifying a second set of beam prediction resources.

In some examples, an UCI message, a MAC-CE, an RRC message, or a combination thereof.

In some examples, the switching manager 1340 may be configured as or otherwise support a means for identifying, based on the beam measurement report, a confidence level associated with each beam in the subset of beams satisfying the performance threshold. In some examples, the switching manager 1340 may be configured as or otherwise support a means for transmitting, to the UE, a request to switch to a second beam measurement reporting scheme based on a confidence level, the confidence level associated with each beam in the subset of beams satisfying the performance threshold. In some examples, the beam measurement report is received in one or more of an UCI message, an RRC message, a MAC-CE, or a combination thereof, and a second beam measurement report associated with the beam measurement report is transmitted in a second UCI message, a second RRC message, a second MAC-CE, or a combination thereof.

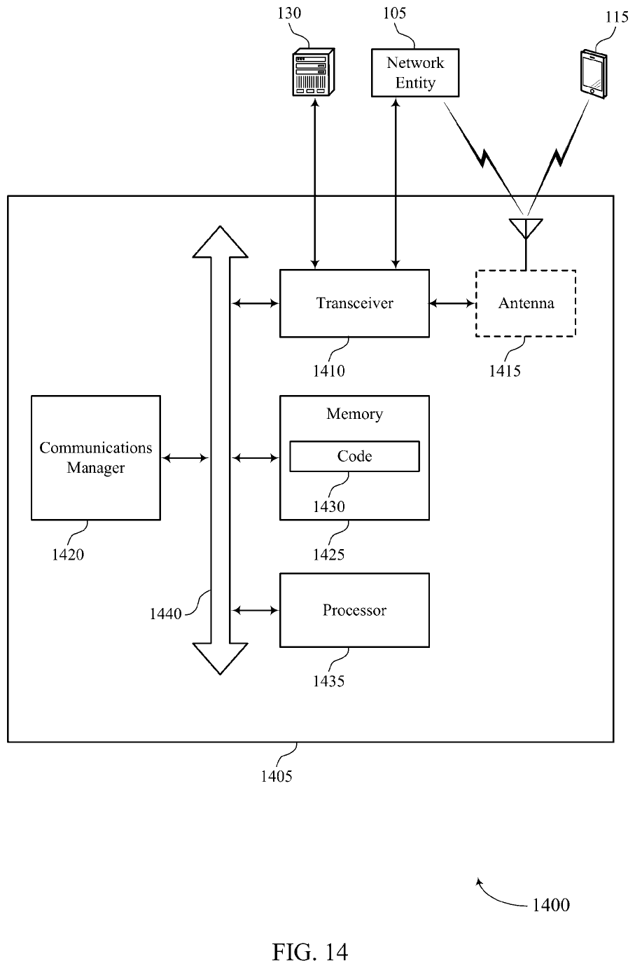

FIG. 14 illustrates a diagram of a system 1400 including a device 1405 that supports indication of beam identifier in beam prediction reporting in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting indication of beam identifier in beam prediction reporting). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting, to a UE, a signal indicating measurement reporting parameters for the UE, the measurement reporting parameters identifying a set of beam prediction resources for a set of beams and a beam measurement reporting scheme. The communications manager 1420 may be configured as or otherwise support a means for receiving, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme.

By including or configuring the communications manager 1420 in accordance with examples as described herein, the device 1405 may support techniques for improved flexibility and efficiency in prediction results reporting using beam prediction reporting schemes where the UE reports the resource identifiers for the top K beams in the prediction resource set or reports both the resource identifiers as well as the predicted measurement results in the prediction results reporting.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of indication of beam identifier in beam prediction reporting as described herein, or the processor 1435 and the memory 1425 may be otherwise configured to perform or support such operations.

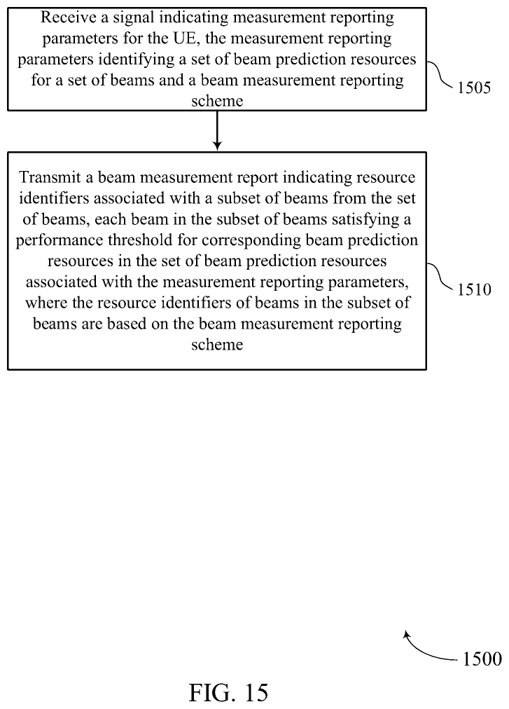

FIG. 15 illustrates a flowchart showing a method 1500 that supports indication of beam identifier in beam prediction reporting in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a signal indicating measurement reporting parameters for the UE, the measurement reporting parameters identifying a set of beam prediction resources for a set of beams and a beam measurement reporting scheme. The operations of 1505 may be performed in accordance with examples as disclosed herein. In some examples, aspects of the operations of 1505 may be performed by a reporting parameter manager 925 as described with reference to FIG. 9.

At 1510, the method may include transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme. The operations of 1510 may be performed in accordance with examples as disclosed herein. In some examples, aspects of the operations of 1510 may be performed by a beam reporting manager 930 as described with reference to FIG. 9.

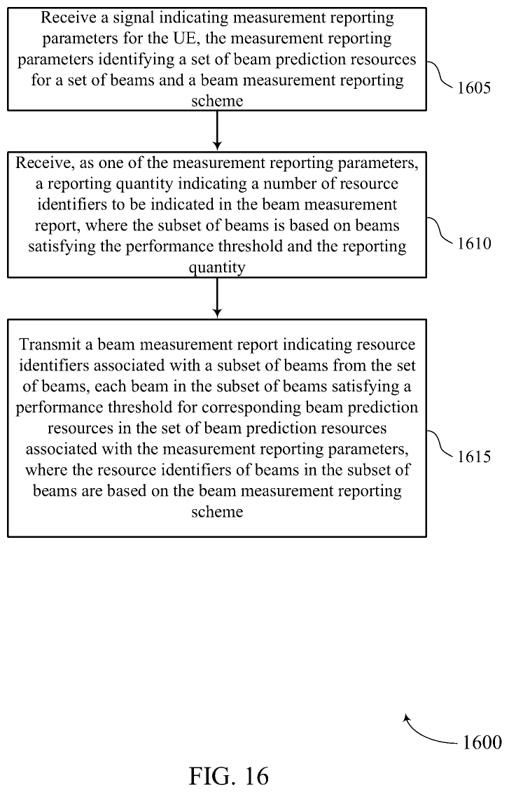

FIG. 16 illustrates a flowchart showing a method 1600 that supports indication of beam identifier in beam prediction reporting in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a signal indicating measurement reporting parameters for the UE, the measurement reporting parameters identifying a set of beam prediction resources for a set of beams and a beam measurement reporting scheme. The operations of 1605 may be performed in accordance with examples as disclosed herein. In some examples, aspects of the operations of 1605 may be performed by a reporting parameter manager 925 as described with reference to FIG. 9.

At 1610, the method may include receiving, as one of the measurement reporting parameters, a reporting quantity indicating a number of resource identifiers to be indicated in the beam measurement report, where the subset of beams is based on beams satisfying the performance threshold and the reporting quantity. The operations of 1610 may be performed in accordance with examples as disclosed herein. In some examples, aspects of the operations of 1610 may be performed by a reporting quantity manager 935 as described with reference to FIG. 9.

At 1615, the method may include transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme. The operations of 1615 may be performed in accordance with examples as disclosed herein. In some examples, aspects of the operations of 1615 may be performed by a beam reporting manager 930 as described with reference to FIG. 9.

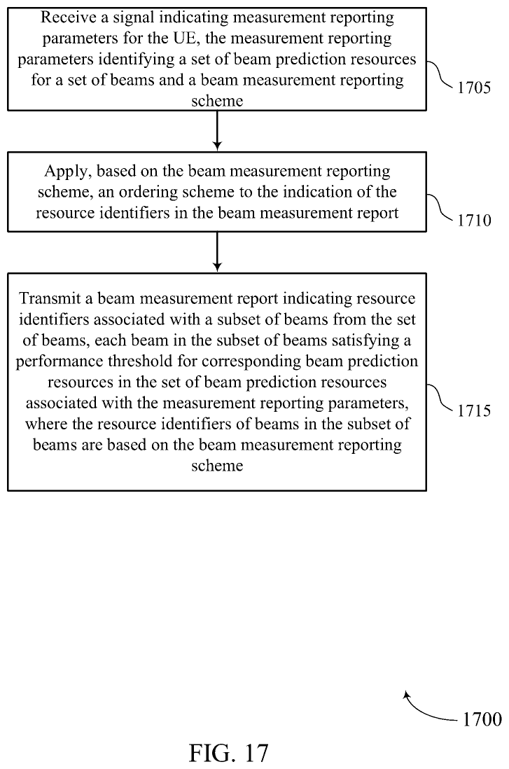

FIG. 17 illustrates a flowchart showing a method 1700 that supports indication of beam identifier in beam prediction reporting in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a signal indicating measurement reporting parameters for the UE, the measurement reporting parameters identifying a set of beam prediction resources for a set of beams and a beam measurement reporting scheme. The operations of 1705 may be performed in accordance with examples as disclosed herein. In some examples, aspects of the operations of 1705 may be performed by a reporting parameter manager 925 as described with reference to FIG. 9.

At 1710, the method may include applying, based on the beam measurement reporting scheme, an ordering scheme to the indication of the resource identifiers in the beam measurement report. The operations of 1710 may be performed in accordance with examples as disclosed herein. In some examples, aspects of the operations of 1710 may be performed by an ordering manager 940 as described with reference to FIG. 9.

At 1715, the method may include transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme. The operations of 1715 may be performed in accordance with examples as disclosed herein. In some examples, aspects of the operations of 1715 may be performed by a beam reporting manager 930 as described with reference to FIG. 9.

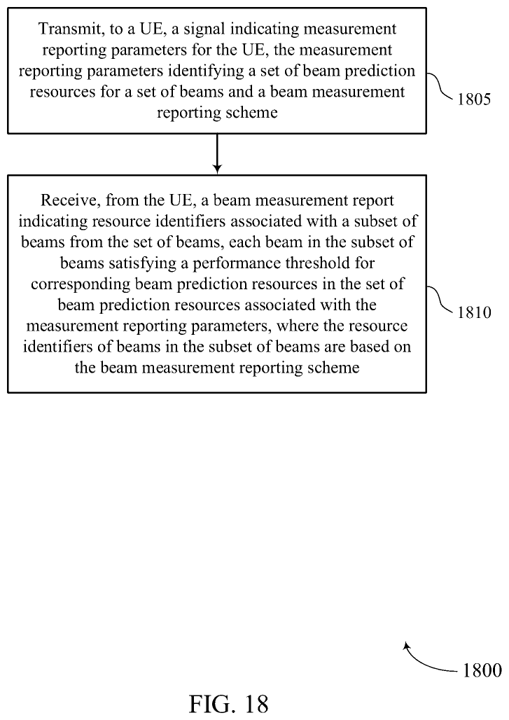

FIG. 18 illustrates a flowchart showing a method 1800 that supports indication of beam identifier in beam prediction reporting in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, a signal indicating measurement reporting parameters for the UE, the measurement reporting parameters identifying a set of beam prediction resources for a set of beams and a beam measurement reporting scheme. The operations of 1805 may be performed in accordance with examples as disclosed herein. In some examples, aspects of the operations of 1805 may be performed by a reporting parameter manager 1325 as described with reference to FIG. 13.

At 1810, the method may include receiving, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme. The operations of 1810 may be performed in accordance with examples as disclosed herein. In some examples, aspects of the operations of 1810 may be performed by a beam reporting manager 1330 as described with reference to FIG. 13.

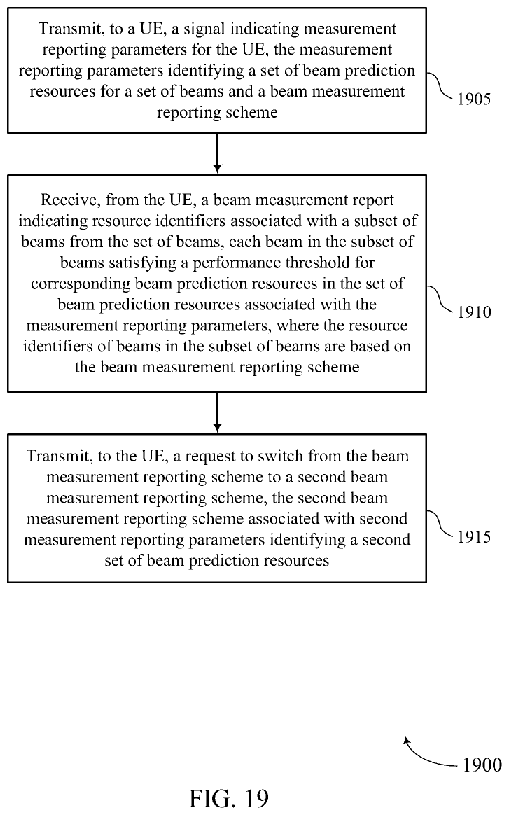

FIG. 19 illustrates a flowchart showing a method 1900 that supports indication of beam identifier in beam prediction reporting in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE, a signal indicating measurement reporting parameters for the UE, the measurement reporting parameters identifying a set of beam prediction resources for a set of beams and a beam measurement reporting scheme. The operations of 1905 may be performed in accordance with examples as disclosed herein. In some examples, aspects of the operations of 1905 may be performed by a reporting parameter manager 1325 as described with reference to FIG. 13.

At 1910, the method may include receiving, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, where the resource identifiers of beams in the subset of beams are based on the beam measurement reporting scheme. The operations of 1910 may be performed in accordance with examples as disclosed herein. In some examples, aspects of the operations of 1910 may be performed by a beam reporting manager 1330 as described with reference to FIG. 13.

At 1915, the method may include transmitting, to the UE, a request to switch from the beam measurement reporting scheme to a second beam measurement reporting scheme, the second beam measurement reporting scheme associated with second measurement reporting parameters identifying a second set of beam prediction resources. The operations of 1915 may be performed in accordance with examples as disclosed herein. In some examples, aspects of the operations of 1915 may be performed by a switching manager 1340 as described with reference to FIG. 13.

The following provides an overview of aspects of the present disclosure:
Aspect 1: A method for wireless communication at a UE, comprising: receiving a signal indicating measurement reporting parameters for the UE, the measurement reporting parameters identifying a set of beam prediction resources for a set of beams and a beam measurement reporting scheme; and transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, wherein the resource identifiers of beams in the subset of beams are based at least in part on the beam measurement reporting scheme.
Aspect 2: The method of aspect 1, further comprising: receiving, as one of the measurement reporting parameters, a reporting quantity indicating a number of resource identifiers to be indicated in the beam measurement report, wherein the subset of beams is based at least in part on beams satisfying the performance threshold and the reporting quantity
Aspect 3: The method of aspect 2, wherein the performance threshold is based at least in part on a predicted reference signal received power (RSRP), a predicted signal-to-interference-plus-noise ratio (SINR), or both, of each beam in the subset of beams being higher than the RSRP, SINR, or both, of remaining beams in the set of beams.
Aspect 4: The method of any of aspects 1 through 3, further comprising: applying, based at least in part on the measurement reporting scheme, an ordering scheme to the resource identifiers indicated in the beam measurement report.
Aspect 5: The method of aspect 4, wherein according to the ordering scheme each resource identifier is ordered within the beam measurement report according to a predicted beam measurement result associated with each beam in the subset of beams.
Aspect 6: The method of claim 4, wherein the ordering scheme defines a bitmap associated with the set of beam prediction resources, each bit in the bitmap corresponds to a beam in the set of beams, with each bit being set to indicate that the beam is included in the subset of beams.
Aspect 7: The method of claim 4, wherein the ordering scheme defines a combinatorial index based at least in part on a first number of beam prediction resources in the set of beam prediction resources and second number of beams in the subset of beams.
Aspect 8: The method of any of aspects 1 through 7, further comprising: setting a first field in the beam measurement report to indicate transmission of a second beam measurement report according to second measurement reporting parameters identifying a second beam measurement reporting scheme; and transmitting, according to the second beam measurement reporting scheme, the second beam measurement report indicating resource identifiers associated with a second subset of beams from a second set of beams and a predicted measurement result for each beam in the second subset of beams, the second beam measurement report further comprising a second field associating the second beam measurement report with the beam measurement report.
Aspect 9: The method of aspect 8, wherein the set of beam prediction resources and a second set of beam prediction resources identified by the second beam measurement reporting parameters comprise a same resource set.
Aspect 10: The method of any of aspects 1 through 9, further comprising: transmitting a request to switch from the beam measurement reporting scheme to a second beam measurement reporting scheme, the second beam measurement reporting scheme associated with second measurement reporting parameters identifying a second set of beam prediction resources.
Aspect 11: The method of aspect 10, wherein the request is transmitted in one or more of an UCI message, a MAC-CE, an RRC message, or a combination thereof.
Aspect 12: The method of any of aspects 1 through 11, further comprising: receiving a request to switch to a second beam measurement reporting scheme based at least in part on a confidence level, the confidence level associated with each beam in the subset of beams satisfying the performance threshold.
Aspect 13: The method of any of aspects 1 through 12, wherein the beam measurement report is received in one or more of an UCI message, an RRC message, a MAC-CE, or a combination thereof, and a second beam measurement report associated with the beam measurement report is transmitted in a second UCI message, a second RRC message, a second MAC-CE, or a combination thereof.
Aspect 14: A method for wireless communication at a network entity, comprising: transmitting, to a UE, a signal indicating measurement reporting parameters for the UE, the measurement reporting parameters identifying a set of beam prediction resources for a set of beams and a beam measurement reporting scheme; and receiving, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, wherein the resource identifiers of beams in the subset of beams are based at least in part on the beam measurement reporting scheme.
Aspect 15: The method of aspect 14, further comprising: transmitting, as one of the measurement reporting parameters, a reporting quantity a number of resource identifiers to be indicated in the beam measurement report, wherein the subset of beams is based at least in part on the beams satisfying the performance threshold and the reporting quantity.
Aspect 16: The method of any of aspects 14 through 15, further comprising: identifying a first field in the beam measurement report that indicates transmission of a second beam measurement report from the UE according to second measurement reporting parameters identifying a second beam measurement reporting scheme; and receiving, according to the second beam measurement reporting scheme, the second beam measurement report indicating resource identifiers associated with a second subset of beams from a second set of beams and a predicted measurement result for each beam in the second subset of beams, the second beam measurement report further comprising a second field associating the second beam measurement report with the beam measurement report.
Aspect 17: The method of aspect 16, wherein the set of beam prediction resources and a second set of beam prediction resources identified by the second beam measurement reporting parameters comprise a same resource set.
Aspect 18: The method of any of aspects 14 through 17, further comprising: transmitting, to the UE, a request to switch from the beam measurement reporting scheme to a second beam measurement reporting scheme, the second beam measurement reporting scheme associated with second measurement reporting parameters identifying a second set of beam prediction resources.
Aspect 19: The method of aspect 18, wherein the request is received in one or more of an UCI message, a MAC-CE, an RRC message, or a combination thereof.
Aspect 20: The method of any of aspects 14 through 19, further comprising: identifying, based at least in part on the beam measurement report, a confidence level associated with each beam in the subset of beams satisfying the performance threshold; and transmitting, to the UE, a request to switch to a second beam measurement reporting scheme based at least in part on a confidence level, the confidence level associated with each beam in the subset of beams satisfying the performance threshold.
Aspect 21: The method of any of aspects 14 through 20, wherein the beam measurement report is received in one or more of an UCI message, an RRC message, a MAC-CE, or a combination thereof, and a second beam measurement report associated with the beam measurement report is transmitted in a second UCI message, a second RRC message, a second MAC-CE, or a combination thereof.
Aspect 22: An apparatus for wireless communication at a UE, comprising a processor: memory coupled with the processor; and instructions stored in the memory and executable by the processor to cause the apparatus to perform a method of any of aspects 1 through 13.
Aspect 23: An apparatus for wireless communication at a UE, comprising at least one means for performing a method of any of aspects 1 through 13.
Aspect 24: A non-transitory computer-readable medium storing code for wireless communication at a UE, the code comprising instructions executable by a processor to perform a method of any of aspects 1 through 13.
Aspect 25: An apparatus for wireless communication at a network entity, comprising a processor: memory coupled with the processor; and instructions stored in the memory and executable by the processor to cause the apparatus to perform a method of any of aspects 14 through 21.
Aspect 26: An apparatus for wireless communication at a network entity, comprising at least one means for performing a method of any of aspects 14 through 21.
Aspect 27: A non-transitory computer-readable medium storing code for wireless communication at a network entity, the code comprising instructions executable by a processor to perform a method of any of aspects 14 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive a signal indicating measurement reporting parameters for the UE, the measurement reporting parameters identifying a set of beam prediction resources for a set of beams and a beam measurement reporting scheme; and
transmit a beam measurement report indicating resource identifiers associated with a subset of beams from the set of beams, each beam in the subset of beams satisfying a performance threshold for corresponding beam prediction resources in the set of beam prediction resources associated with the measurement reporting parameters, wherein the resource identifiers of beams in the subset of beams are based at least in part on the beam measurement reporting scheme.

2. The apparatus of claim 1, wherein the instructions are further executable by the processor to cause the apparatus to:
receive, as one of the measurement reporting parameters, a reporting quantity indicating a number of resource identifiers to be indicated in the beam measurement report, wherein the subset of beams is based at least in part on beams satisfying the performance threshold and the reporting quantity.

3. The apparatus of claim 2, wherein the performance threshold is based at least in part on a predicted reference signal received power (RSRP), a predicted signal-to-interference-plus-noise ratio (SINR), or both, of each beam in the subset of beams being higher than the RSRP, SINR, or both, of remaining beams in the set of beams.

4. The apparatus of claim 1, wherein the instructions are further executable by the processor to cause the apparatus to:
apply, based at least in part on the beam measurement reporting scheme, an ordering scheme to the resource identifiers indicated in the beam measurement report.

5. The apparatus of claim 4, wherein according to the ordering scheme each resource identifier is ordered within the beam measurement report according to a predicted beam measurement result associated with each beam in the subset of beams.

6. The apparatus of claim 4, wherein the ordering scheme defines a bitmap associated with the set of beam prediction resources, each bit in the bitmap corresponds to a beam in the set of beams, with each bit being set to indicate that the beam is included in the subset of beams.

7. The apparatus of claim 4, wherein the ordering scheme defines a combinatorial index based at least in part on a first number of beam prediction resources in the set of beam prediction resources and second number of beams in the subset of beams.

8. The apparatus of claim 1, wherein the instructions are further executable by the processor to cause the apparatus to:
set a first field in the beam measurement report to indicate transmission of a second beam measurement report according to second measurement reporting parameters identifying a second beam measurement reporting scheme; and
transmit, according to the second beam measurement reporting scheme, the second beam measurement report indicating resource identifiers associated with a second subset of beams from a second set of beams and a predicted measurement result for each beam in the second subset of beams, the second beam measurement report further comprising a second field associating the second beam measurement report with the beam measurement report.

9. The apparatus of claim 8, wherein the set of beam prediction resources and a second set of beam prediction resources identified by the second beam measurement reporting parameters comprise a same resource set.

10. The apparatus of claim 1, wherein the instructions are further executable by the processor to cause the apparatus to:
transmit a request to switch from the beam measurement reporting scheme to a second beam measurement reporting scheme, the second beam measurement reporting scheme associated with second measurement reporting parameters identifying a second set of beam prediction resources.

11. The apparatus of claim 10, wherein the request is transmitted in one or more of: an uplink control information (UCI) message, a medium access control-control element (MAC-CE), a radio resource control (RRC) message, or a combination thereof.

12. The apparatus of claim 1, wherein the instructions are further executable by the processor to cause the apparatus to:
receive a request to switch to a second beam measurement reporting scheme based at least in part on a confidence level, the confidence level associated with each beam in the subset of beams satisfying the performance threshold.

13. The apparatus of claim 1, wherein the beam measurement report is received in one or more of an uplink control information (UCI) message, a radio resource control (RRC) message, a medium access control-control element (MAC-CE), or a combination thereof, and a second beam measurement report associated with the beam measurement report is transmitted in a second UCI message, a second RRC message, a second MAC-CE, or a combination thereof.

14. An apparatus for wireless communication at a network entity, comprising:
a processor;
memory coupled with the processor; and
instructions stored in the memory and executable by the processor to cause the apparatus to:
transmit, to a user equipment (UE), a signal indicating measurement reporting parameters for the UE, the measurement reporting parameters identifying a set of beam prediction resources for a set of beams and a beam measurement reporting scheme; and
receive, from the UE, a beam measurement report indicating resource identifiers associated with a subset of beams from the set of beams, each beam in the subset of beams satisfying a performance threshold for corresponding beam prediction resources in the set of beam prediction resources associated with the measurement reporting parameters, wherein the resource identifiers of beams in the subset of beams are based at least in part on the beam measurement reporting scheme.

15. The apparatus of claim 14, wherein the instructions are further executable by the processor to cause the apparatus to:
transmit, as one of the measurement reporting parameters, a reporting quantity a number of resource identifiers to be indicated in the beam measurement report, wherein the subset of beams is based at least in part on the beams satisfying the performance threshold and the reporting quantity.

16. The apparatus of claim 14, wherein the instructions are further executable by the processor to cause the apparatus to:
identify a first field in the beam measurement report that indicates transmission of a second beam measurement report from the UE according to second measurement reporting parameters identifying a second beam measurement reporting scheme; and
receive, according to the second beam measurement reporting scheme, the second beam measurement report indicating resource identifiers associated with a second subset of beams from a second set of beams and a predicted measurement result for each beam in the second subset of beams, the second beam measurement report further comprising a second field associating the second beam measurement report with the beam measurement report.

17. The apparatus of claim 16, wherein the set of beam prediction resources and a second set of beam prediction resources identified by the second beam measurement reporting parameters comprise a same resource set.

18. The apparatus of claim 14, wherein the instructions are further executable by the processor to cause the apparatus to:
transmit, to the UE, a request to switch from the beam measurement reporting scheme to a second beam measurement reporting scheme, the second beam measurement reporting scheme associated with second measurement reporting parameters identifying a second set of beam prediction resources.

19. The apparatus of claim 18, wherein the request is transmitted in one or more of: an uplink control information (UCI) message, a medium access control-control element (MAC-CE), a radio resource control (RRC) message, or a combination thereof.

20-21. (canceled)

22. A method for wireless communication at a user equipment (UE), comprising:
receiving a signal indicating measurement reporting parameters for the UE, the measurement reporting parameters identifying a set of beam prediction resources for a set of beams and a beam measurement reporting scheme; and
transmitting a beam measurement report indicating resource identifiers associated with a subset of beams from the set of beams, each beam in the subset of beams satisfying a performance threshold for corresponding beam prediction resources in the set of beam prediction resources associated with the measurement reporting parameters, wherein the resource identifiers of beams in the subset of beams are based at least in part on the beam measurement reporting scheme.

23-30. (canceled)
